(19) United States
(12) Patent Application Publication
(10) Pub. No.: US 2026/0342631 A1
(43) Pub. Date: Oct. 29, 2026

(54) CYCLIC PREFIX FOR SENSING SIGNAL TRANSMISSION IN JOINT COMMUNICATION AND SENSING SYSTEM

(71) Applicant: QUALCOMM Incorporated, San Diego, CA (US)

(72) Inventors: Shijun WU, San Diego, CA (US); Stelios STEFANATOS, San Diego, CA (US); Kapil GULATI, Belle Mead, NJ (US); Preeti KUMARI, San Diego, CA (US)

(21) Appl. No.: 19/157,277

(22) PCT Filed: Feb. 28, 2024
(86) PCT No.: PCT/US2024/017739

§ 371 Date: Aug. 15, 2025

(30) Foreign Application Priority Data
Mar. 28, 2023 (GR) 20230100260

(51) Int. Cl. H04L 27/26

(52) U.S. Cl. CPC H04L 27/261; H04L 27/2678

(57) ABSTRACT

The apparatus may be a wireless device or a UE that may be configured to transmit an SRS using a first CP-length configuration, where the first CP-length configuration is different from a second CP-length configuration associated with communication. The apparatus may further be configured to receive a reflected SRS based on transmitting the SRS and/or to receive, based on the SRS, an indication of at least one value associated with a corresponding at least one object in an environment of the wireless device. The apparatus may be a network device configured to receive a reflected SRS using the first CP-length configuration. The apparatus may further be configured to transmit, to a wireless device and based on the reflected SRS, an indication of at least one value associated with a corresponding at least one object in an environment of the wireless device.

### CROSS-REFERENCE TO RELATED APPLICATION

This application claims the benefit of Greek patent application No. 20230100260, entitled “CYCLIC PREFIX FOR SENSING SIGNAL TRANSMISSION IN JOINT COMMUNICATION AND SENSING SYSTEM” and filed on Mar. 28, 2023, which is expressly incorporated by reference herein in its entirety.

### TECHNICAL FIELD

The present disclosure relates generally to communication systems, and more particularly, to a system capable of sensing, e.g., radio assisted detection and ranging (RADAR), and communication via a same set of frequency resources.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP™) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device or a user equipment (UE) that may be associated with joint sensing and communication operations and/or a vehicle. The apparatus may be configured to transmit a sensing reference signal (SRS) using a first cyclic prefix (CP)-length configuration, where the first CP-length configuration is different from a second CP-length configuration associated with communication. The apparatus may further be configured to receive a reflected SRS based on transmitting the SRS.

In an aspect of the disclosure, a method, a computer-readable medium, and an apparatus are provided. The apparatus may be a network device configured to receive a reflected SRS using a first CP-length configuration, where the first CP-length configuration is different from a second CP-length configuration associated with communication. The apparatus may further be configured to transmit, to a wireless device and based on the reflected SRS, an indication of at least one value associated with a corresponding at least one object in an environment of the wireless device.

In an aspect of the disclosure, a method, a computer-readable medium, and an apparatus are provided. The apparatus may be a wireless device or a UE that may be associated with joint sensing and communication operations and/or a vehicle. The apparatus may be configured to transmit an SRS using a first CP-length configuration, where the first CP-length configuration is different from a second CP-length configuration associated with communication. The apparatus may further be configured to receive, based on the SRS, an indication of at least one value associated with a corresponding at least one object in an environment of the wireless device.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and UE in an access network.

FIG. 4 is a diagram illustrating an example of FMCW signals generated from a radar device that may be used to measure at least one value associated with at least one associated with a corresponding at least one object in an environment of the radar device in accordance with various aspects of the present disclosure.

FIG. 5 is a diagram illustrating a wireless device performing a sensing operation associated with a set of wireless devices and target objects in an environment of the wireless device in accordance with some aspects of the disclosure.

FIG. 6 includes a first diagram illustrating a set of four slots associated with a 120 kHz subcarrier spacing (SCS) without the introduction of extra CP to ensure alignment every and a second diagram illustrating a set of four slots associated with a 120 kHz SCS with the introduction of extra CP to ensure alignment every.

FIG. 7 includes a diagram illustrating a non-uniform SRS interval resulting from the addition of an extra CP.

FIG. 8 includes a diagram illustrating a CP configuration associated with equal-length CP for each symbol in a modified slot structure associated with at least an SRS coherent processing interval (CPI) in accordance with some aspects of the disclosure.

FIG. 9 includes a first diagram illustrating a CP configuration associated with normal CP for each symbol in a modified subframe and/or frame structure associated with at least an SRS CPI and a second diagram illustrating a first set of frequency resources associated with sensing signal transmission and a second set of frequency resources associated with communication transmission in accordance with some aspects of the disclosure.

FIG. 10 is a diagram illustrating a CP configuration associated with additional CP samples added to a first slot in each half slot in a modified slot structure associated with at least an SRS CPI in accordance with some aspects of the disclosure.

FIG. 11 is a call flow diagram illustrating a vehicular UE performing sensing and communication operations in accordance with some aspects of the disclosure.

FIG. 12 is a flowchart of a method of wireless communication associated with a sensing operation.

FIG. 13 is a flowchart of a method of wireless communication associated with a sensing operation.

FIG. 14 is a flowchart of a method of wireless communication associated with a sensing operation.

FIG. 15 is a flowchart of a method of wireless communication associated with a sensing operation.

FIG. 16 is a flowchart of a method of wireless communication associated with a sensing operation.

FIG. 17 is a diagram illustrating an example of a hardware implementation for an example apparatus and/or network entity.

FIG. 18 is a diagram illustrating an example of a hardware implementation for an example network entity.

FIG. 19 is a diagram illustrating an example of a hardware implementation for an example network entity.

### DETAILED DESCRIPTION

Various aspects of the disclosure relate generally to jointly designed sensing and communication systems, e.g., including in automotive applications, that have the potential to reduce hardware costs. In a joint sensing and communication system, a communication system (e.g., such as a UE that may be located in, or associated with, a vehicle in some examples) may transmit signals for sensing, e.g., to detect surrounding (e.g., such as objects around the vehicle) based on reflections of the transmitted signals. For example, in a monostatic mode of operation the reflections may be received by the communication system (e.g., the UE), while in a bistatic mode of operation the reflections may be received by another device (e.g., a UE or base station) and information based on the reflections may be provided to the communication system. The communication system, in some aspects, may transmit sensing signals using a mmWave band that is additionally designated for wireless communication but may be underutilized. In some aspects, a UE may transmit a sensing signal (e.g., a plurality of transmissions for a sensing operation) on uplink resources of a wireless communication network. For example, the sensing signal may use the same waveform as being used in the communication system (e.g., CP-OFDM). In some aspects, an SRS may be specified based on minimum accuracy or resolution. The resources used for an SRS transmission, in some aspects, may be configured or allocated by a network entity, e.g., a base station or network node.

Velocity (or speed) estimation, in some aspects, may be important for various applications, including automotive applications, and particular accuracy and/or resolution may be associated with a duration of an SRS. For example, an SRS transmission lasting 5 ms or longer, which may be referred to as a CPI in the context of RADAR, may be a minimum time interval to achieve 1 m/s velocity (or speed) resolution. During the SRS transmission, e.g., the CPI, a plurality of SRS instances may be transmitted with an interval based on a range of velocities to be identified and/or estimated using the SRS instances. The SRS may span a number, N, of slots (or ms), and the SRS instances may be transmitted via a subset of symbols within the within the N slots (or ms).

If an interval (e.g., an SRS interval or SRS transmission interval) between SRS instances is constant/equal for different SRS instances, a first processing of the SRS instances may be used for velocity determination. For unequal intervals between the SRS instances, a second, more sophisticated and/or more complicated processing of the SRS instances may be used for velocity determination. The decision to use one of equal, or unequal, intervals may be based on balancing the complexity of processing the SRS instances and a complexity of maintaining acceptable overhead to support system capacity for sensing while minimizing impact to communication performance. For example, in some aspects, a wireless device may transmit an SRS using a first CP-length configuration, where the first CP-length configuration is different from a second CP-length configuration associated with communication. The wireless device, in a monostatic mode of operation, may receive a reflected SRS based on transmitting the SRS and may calculate at least one value associated with a corresponding at least one object in an environment of the wireless device based on the SRS and the reflected SRS. In a bistatic mode of operation, a base station, or other wireless device, may receive the reflected SRS using the first CP-length configuration and calculating at least one value associated with a corresponding at least one object in an environment of the wireless device based on the SRS and the reflected SRS. The base station, or other wireless device, may transmit, and the wireless device transmitting the SRS may receive, an indication of the at least one value. The SRS may include a set of SRS instances with a first periodicity (e.g., an interval in time between SRS instances or a number of symbols between SRS instances) over multiple slots and/or ms, where the first CP-length configuration is configured to maintain equal intervals in time based on a number of symbols between SRS instances.

Particular aspects of the subject matter described in this disclosure can be implemented to realize one or more of the following potential advantages. The CP-length configuration may be used to simplify SRS processing for sensing applications performed by a joint sensing and communication wireless device.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

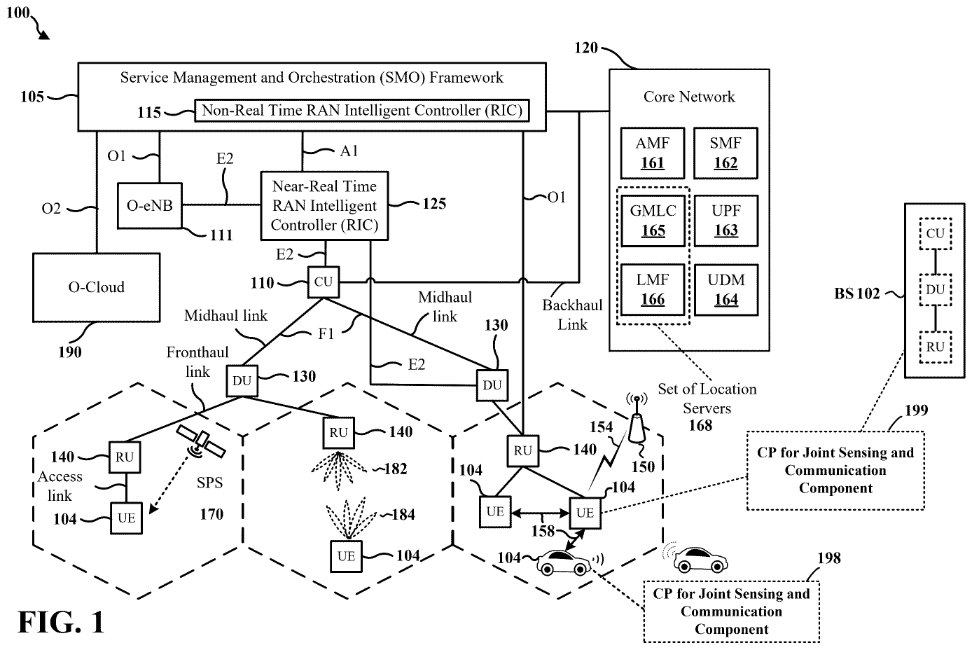

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP™. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™, Wi-Fi™ based on the Institute of Electrical and Electronics Engineers (IEEE) 802.11 standard, LTE, or NR.

The wireless communications system may further include a Wi-Fi™ AP 150 in communication with UEs 104 (also referred to as Wi-Fi™ stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” or “mmWave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth™ signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a CP for joint sensing and communication component 198 that may be configured to transmit an SRS using a first CP-length configuration, where the first CP-length configuration is different from a second CP-length configuration associated with communication. The CP for joint sensing and communication component 198 may further be configured to receive a reflected SRS based on transmitting the SRS. The CP for joint sensing and communication component 198 may further be configured to receive, based on the SRS, an indication of at least one value associated with a corresponding at least one object in an environment of the wireless device. In certain aspects, the base station 102, or the UE 104, may have a CP for joint sensing and communication component 199 that may be configured to receive a reflected SRS using a first CP-length configuration, where the first CP-length configuration is different from a second CP-length configuration associated with communication. The CP for joint sensing and communication component 199 may further be configured to transmit, to a wireless device and based on the reflected SRS, an indication of at least one value associated with a corresponding at least one object in an environment of the wireless device. While aspects of the disclosure may describe examples including automotive radar systems in order to illustrate the concepts presented herein, the aspects presented herein may also be applied for additional applications for communication systems associated with different aspects of the network.

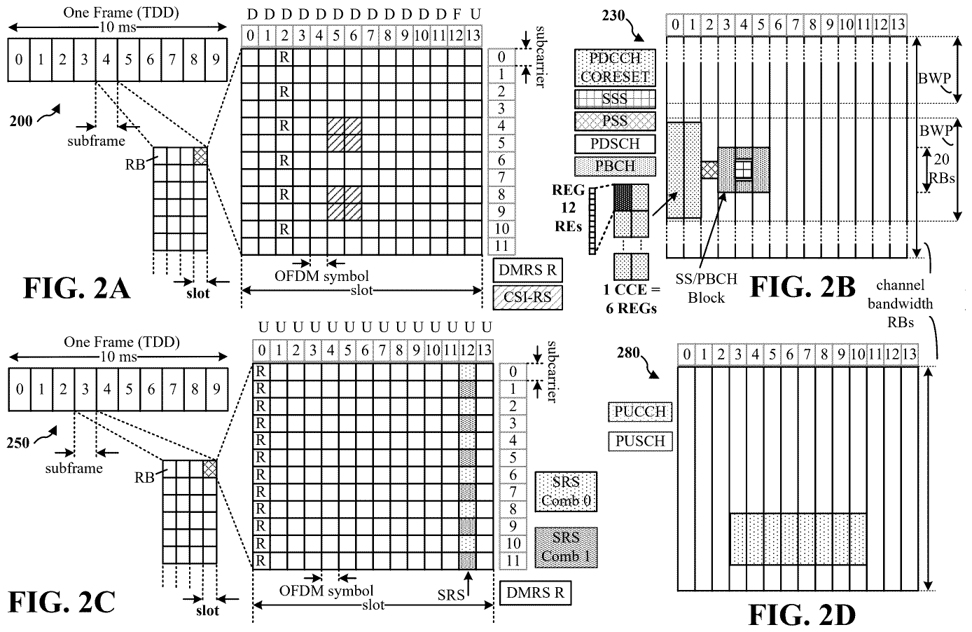

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal (e.g. which may be referred to as normal cyclic prefix (NCP)) or extended (which may be referred to as extended cyclic prefix (ECP)). For normal CP, e.g., NCP, each slot may include 14 symbols, and for extended CP, e.g., ECP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| | Δf = 2^{μ} · 15 | |
| μ | [kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

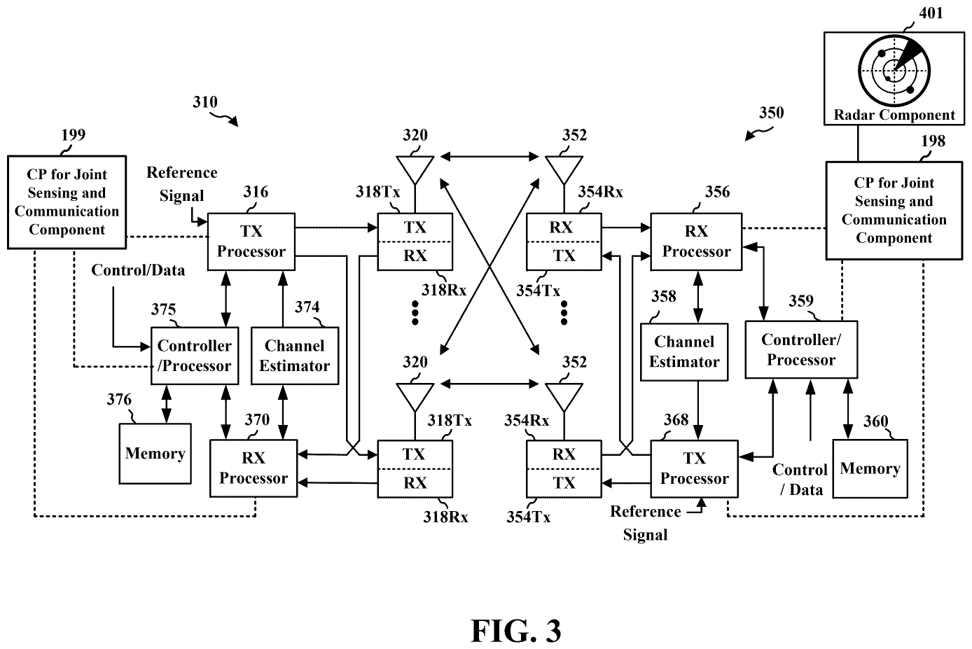

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

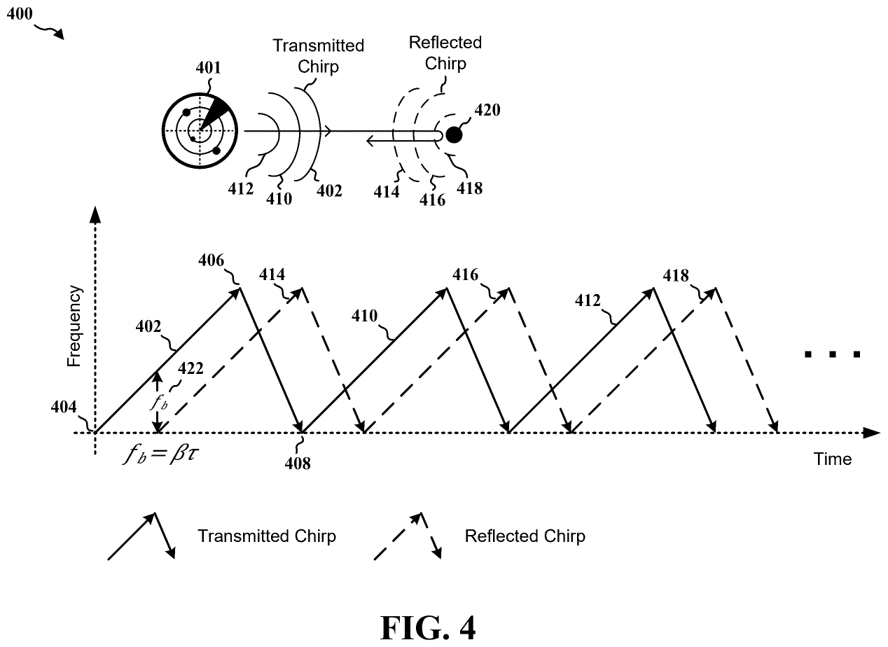

FIG. 4 is a diagram 400 illustrating an example of FMCW signals generated from a radar device 401 (e.g., an FMCW radar) that may be used to measure at least one value associated with a corresponding at least one object in an environment of the radar device in accordance with various aspects of the present disclosure. The radar device 401 may detect an object 420 by transmitting a set of radar transmissions, which may be a set of chirp signals (or may also be referred to as a pulse signals), where each of the chirp signals may have a frequency that varies linearly (e.g., have a frequency sweeping) over a fixed period of time (e.g., over a sweep time) by a modulating signal. For example, as shown by the diagram 400, a transmitted chirp 402 may have a starting frequency at 404 of a sinusoid. Then the frequency may be gradually (e.g., linearly) increased on the sinusoid until it reaches the highest frequency at 406 of the sinusoid, and then the frequency of the signal may return to 408 and another chirp 410 may be transmitted in the same way. In other words, each chirp may include an increase in the frequency (e.g., linearly) and a drop in the frequency, such that the radar device 401 may transmit chirps sweeping in frequency.

After one or more chirps (e.g., chirps 402, 410, 412, etc.) are transmitted by the radar device 401, the transmitted chirps may reach the object 420 and reflect back to the radar device 401, such as shown by the reflected chirps (e.g., reflected chirp 414, reflected chirp 416, and reflected chirp 418, which may correspond to the transmitted chirps 402, 410, and 412, respectively). As there may be a distance between the radar device 401 and the object 420 and/or it may take time for a transmitted chirp to reach the object 420 and reflect back to the radar device 401, a delay may exist between a transmitted chirp and its corresponding reflected chirp. The delay may be proportional to a range between the radar device 401 and the object 420 (e.g., the further the target, the larger the delay and vice versa). Thus, the radar device 401 may be able to measure or estimate a distance between the radar device 401 and the object 420 based on the delay. However, in some examples, it may be difficult for some devices to measure or estimate the distance based on the delay between a transmitted chirp and a reflected chirp.

In other examples, as an alternative, the radar device 401 may measure a difference in frequency between the transmitted chirp and the reflected chirp, which may also be proportional to the distance between the radar device 401 and the object 420. In other words, as the frequency difference between the reflected chirp and the transmitted chirp increases with the delay, and the delay is linearly proportional to the range, the distance of the object 420 from the radar device 401 may also be determined based on the difference in frequency. Thus, the reflected chirp from the object may be mixed with the transmitted chirp and down-converted to produce a beat signal (fp) which may be linearly proportional to the range after demodulation. For example, the radar device 401 may determine a beat signal 422 by mixing the transmitted chirp 402 and its corresponding reflected chirp 414. In some examples, a radar device may also be used to detect the velocity and direction of a using the FMCW. For example, an FMCW receiver may be able to identify the beat frequency/range based on a range spectrum. The FMCW receiver may also be able to identify the velocity based on a Doppler spectrum and/or the direction based on a direction of arrival (DoA) spectrum with multiple chirps.

At least one of the TX processor 368, the RX processor 356, and the controller/processor 359 may be configured to perform aspects in connection with the CP for joint sensing and communication component 198 or CP for joint sensing and communication component 199 of FIG. 1.

At least one of the TX processor 316, the RX processor 370, and the controller/processor 375 may be configured to perform aspects in connection with the CP for joint sensing and communication component 199 of FIG. 1.

Various aspects of the disclosure relate generally to jointly designed sensing and communication systems. In some aspects, the joint sensing and communication system may be applied for automotive applications, among other example applications, that have the potential to reduce hardware costs, e.g., as components may be jointly used for sensing and communication rather than having separate communication components and sensing components. In a joint sensing and communication system, a devices communication system may transmit signals for sensing, e.g., to detect objects around the device based on reflections of the transmitted signals. As one, non-limiting example, a vehicle (e.g., a UE, which may be located at, or associated with, a vehicle) may use the joint communication system to perform sensing around the vehicle. For example, in a monostatic mode of operation the reflections may be received by the UE's communication system, while in a bistatic mode of operation the reflections may be received by another device (e.g., a UE or base station) and information based on the reflections may be provided to the UE. The communication system, in some aspects, may transmit sensing signals using a mmWave band that is additionally designated for wireless communication but may be underutilized. In some aspects, a UE may transmit a sensing signal (e.g., a plurality of transmissions for a sensing operation) on uplink resources of a wireless communication network. For example, the sensing signal may use the same waveform as being used in the communication system (e.g., CP-OFDM). In some aspects, an SRS may be specified based on minimum accuracy or resolution. The resources used for an SRS transmission, in some aspects, may be configured or allocated by a network entity, e.g., a base station or network node.

Velocity estimation, in some aspects, may be important for automotive applications, among other example applications, and particular accuracy and/or resolution may be associated with a duration of an SRS. For example, an SRS transmission lasting 5 ms or longer, which may be referred to as a CPI in the context of RADAR, may be a minimum time interval to achieve 1 m/s velocity resolution. During the SRS transmission, e.g., the CPI, a plurality of SRS instances may be transmitted with an interval based on a range of velocities to be identified and/or estimated using the SRS instances. The SRS may span a number, N, of slots (or ms), and the SRS instances may be transmitted via a subset of symbols within the within the N slots (or ms).

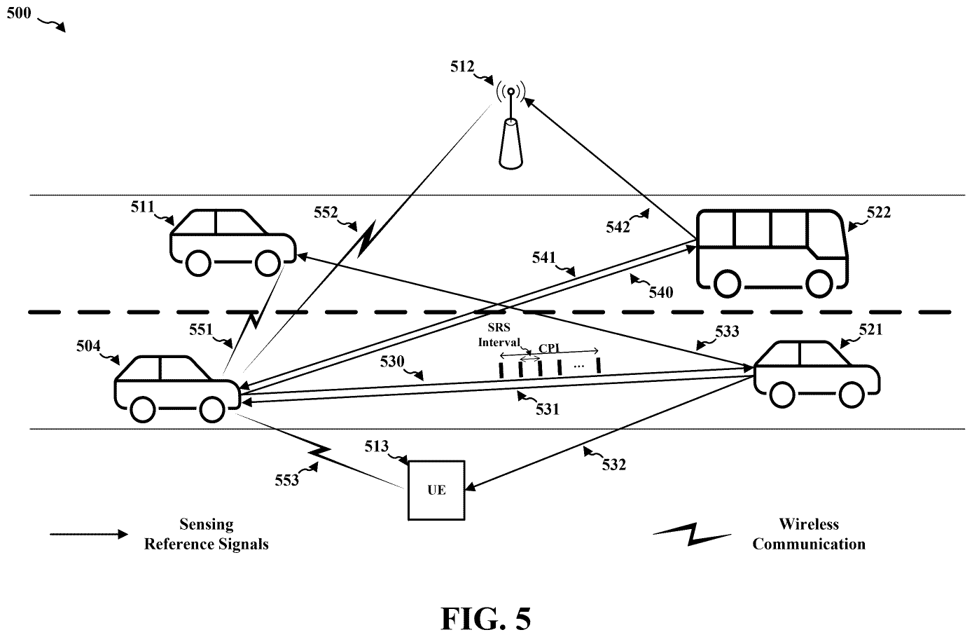

FIG. 5 is a diagram 500 illustrating a wireless device performing a sensing operation associated with a set of wireless devices and target objects in an environment of the wireless device in accordance with some aspects of the disclosure. Diagram 500 illustrates the concept in a vehicle setting, but the aspects presented herein may be employed in a joint communication and sensing device in non-vehicular applications, as well. Diagram 500 illustrates that the wireless device may be a vehicular UE 504 that may transmit SRS 530 and/or SRS 540, where SRS 530 and/or the SRS 540 may be a same SRS, e.g., a same set of SRS instances that (radially) propagate from the vehicular UE 504 in at least the directions associated with the SRS 530 and the SRS 540. The SRS 530 (and the SRS 540) may be associated with a set of SRS instances separated by an SRS interval (a period) and spanning an SRS CPI associated with a sensing operation with a specified range of measurable values (e.g., velocities, positions, etc.) and a specified resolution.

The SRS 530 may be reflected from a target object (e.g., vehicle 521) as a reflected SRS 531, a reflected SRS 532, and a reflected SRS 533. The reflected SRS 531 may be received by the vehicular UE 504 in a monostatic mode of operation. Additionally, or alternatively, the reflected SRS 532 and the reflected SRS 533 may be received by a UE 513 and an additional vehicular UE 511, respectively, in association with a bistatic mode of operation. A receiving device, e.g., the vehicular UE 504, the UE 513, or the additional vehicular UE 511, may then calculate at least one value associated with the target object (e.g., vehicle 521) in the environment of the vehicular UE 504 based on the SRS 530 and a received reflected SRS (e.g., the reflected SRS 531, 532, or 533 received by the vehicular UE 504, the UE 513, or the additional vehicular UE 511, respectively).

Additionally, or alternatively, the SRS 540 may be reflected from an additional target object (e.g., vehicle 522) as a reflected SRS 541 or a reflected SRS 542. The reflected SRS 541 may be received by the vehicular UE 504, and the reflected SRS 542 may be received by a network device 512 (e.g., a base station or road side unit). Each device that receives a reflected SRS, in some aspects, may calculate at least one value associated with the target object from which the reflected SRS (e.g., the reflected SRS 531, 532, 533, 541, or 542) was reflected/received. The calculated value may be based on the SRS and the reflected SRS. In some aspects, the at least one value may be a velocity associated with the target object (e.g., a relative velocity between the vehicular UE 504 and the target object such as vehicle 521 or vehicle 522).

The additional vehicular UE 511, the network device 512, or the UE 513, in some aspects, may, after calculating the at least one value, transmit the at least one calculated value to the vehicular UE 504. The vehicular UE 504, in some aspects, may be connected to the additional vehicular UE 511, the network device 512, and the UE 513 via a connection 551, a connection 552, and a connection 553, respectively. The connections 551, 552, or 553 may be a wireless connection such as one of an RF access link, a communication link, or a sidelink.

In some aspects of wireless communication, e.g., 5G NR, OFDM symbols may be configured with unequal CP lengths. The unequal CP lengths, in some aspects, may be based on a numerology (or subcarrier spacing) that maintains a mapping of a slot, subframe, half subframe, or frame duration to integer numbers of a time unit (e.g., 1 ms s or 0.5 ms). For example, in 5G NR, if normal CP (NCP) is used, extra CP samples may be added to the first OFDM symbol of every 0.5 ms (or half subframe) to match the integer number of a selected time unit (e.g., 1 ms) for the subframe, extra CP samples are added to the first OFDM symbol of every 0.5 ms (every half subframe). For example, for a sampling rate of 491.52 MHz with 4096 FFT and 120 kHz SCS, a number of CP samples for most symbols may be 288 with a first OFDM symbol of each 0.5 ms duration including 256 extra CP samples. With this example CP-length configuration, if SRS instances occur, or are scheduled, every 4 symbols beginning at a second symbol of a subframe, the time interval between a first SRS instance and a second SRS instance may be 35.68 μs while a time interval between two SRS instances on either side of a first OFDM symbol of a half subframe may be 36.26 μs.

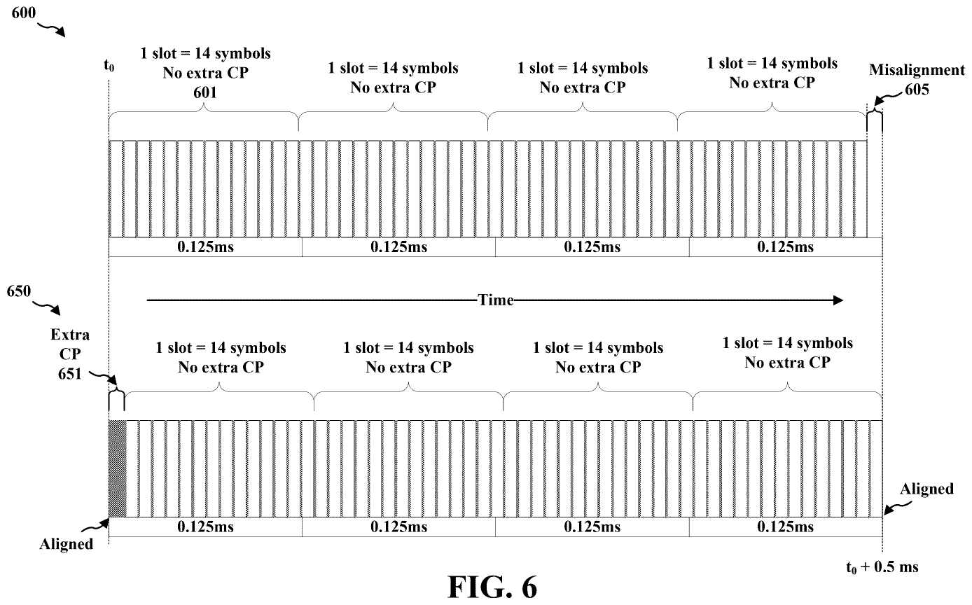

FIG. 6 includes a first diagram 600 illustrating a set of four slots associated with a 120 kHz SCS without the introduction of extra CP to ensure alignment every 0.5 ms and a second diagram 650 illustrating a set of four slots associated with a 120 kHz SCS with the introduction of extra CP to ensure alignment every 0.5 ms. As illustrated in diagram 600, a first slot 601 that includes a normal CP (NCP) of a first length (e.g., 288 samples) associated with each symbol (e.g., including 4096 samples in addition to the 288 samples of NCP) but does not include extra CP may begin in alignment with a half subframe at a first time, to, but will last slightly less than 0.125 ms. Similarly, subsequent slots without extra CP may, in some aspects, last slightly less than 0.125 ms such that after four slots making up a half subframe (e.g., for the 120 kHz SCS) the slots may be misaligned from the time specified for a half subframe (e.g., 0.5 ms) by misalignment 605 (exaggerated for illustrative purposes).

In some aspects, to avoid the misalignment 605 resulting from each slot lasting slightly less than one-fourth of a half subframe (e.g., one-fourth of 0.5 ms, or 0.125 ms), extra CP 651 (e.g., 256 samples in addition to the 288 samples of CP for other symbols) may be added to a first symbol of a first slot of a half subframe. Diagram 650 illustrates that by adding extra CP (additional samples to a CP of a first symbol) the alignment of the slots of the half subframe and the time specified for a half subframe may be maintained at a specified point (e.g., the beginning, the end, or after a certain number of symbols or slots) of the half subframe. For example, by adding the extra CP 651, in some aspects, for each symbol (e.g., an i^{th} symbol, or symᵢ) of a particular half subframe may follow a corresponding symbol (e.g., the i^{th} symbol, or symᵢ) of a previous half subframe by exactly 0.5 ms. In diagram 650, for example, the beginning of a first half subframe at the first time, to, is followed by the beginning of a subsequent half subframe at a second time, to +0.5 ms, that is exactly 0.5 ms after the beginning of the first half subframe. In diagrams 600 and 650 the NCP, the misalignment 605, and the extra CP 651, as shown, are not proportional to their actual length for illustrative purposes, e.g., a proportional representation would be difficult to see as the NCP, the misalignment 605, and the extra CP 651 are roughly 1/16^{th} of a symbol length of 4096 samples.

Accordingly, for a CP-length configuration for communication introducing additional CP samples as described above, if SRS instances are transmitted at a frequency that is not an integer multiple of 0.5 ms (e.g., via symbols that are not separated by an integer number of half subframes), there may be unequal time intervals between symbols based on the extra CP added every half subframe. While an extended CP (ECP) CP-length configuration in which all symbols have a same CP length, is supported in some aspects, of wireless communication, in some such aspects, it may be supported for some numerologies but not all, or even most, numerologies. For example, 5G NR supports an ECP for a numerology of 2 (e.g., a 60 kHz SCS) but not for other numerologies. Such non-uniform symbol duration may disrupt velocity estimation in some aspects. For example, performance of DFT-based velocity (Doppler) estimation degrades (becomes less accurate) when interval of SRS symbols is non-uniform.

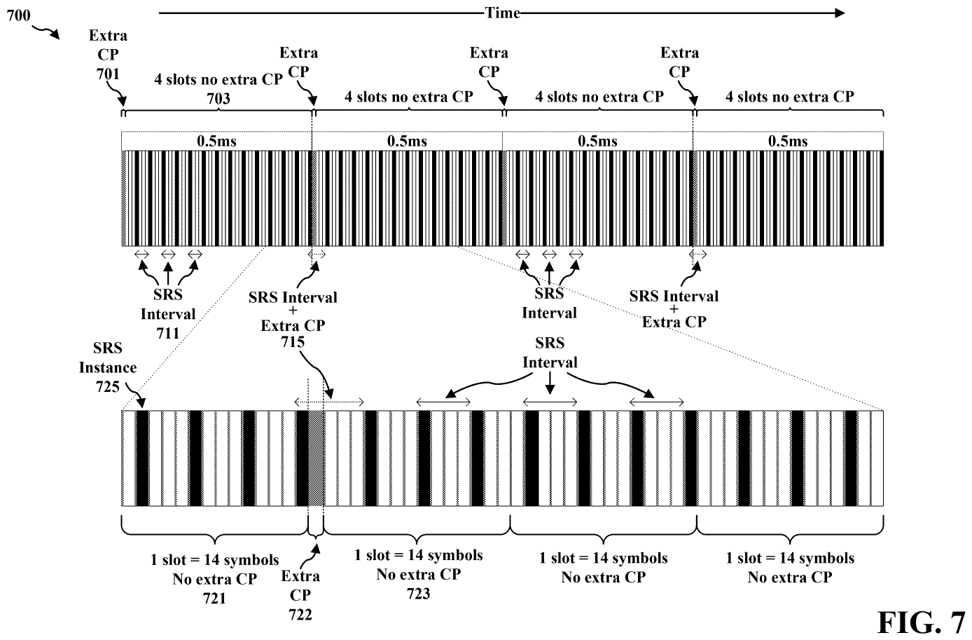

FIG. 7 includes a diagram 700 illustrating a non-uniform SRS interval resulting from the addition of an extra CP. Diagram 700 illustrates a set of four half subframes with extra CP, e.g., the extra CP 701, each including a set of four slots as described in relation to FIG. 6. In some aspects, the slot/subframe structure may be associated with a 120 kHz SCS with larger (or smaller) SCS being associated with more (or fewer) slots per half subframe, where the example illustrated in FIG. 7 is merely one example used to illustrate features that may be common to different SCSs. In some aspects, each SRS instance (e.g., SRS instance 725) may be configured to span an integer number of symbols and an SRS interval (e.g., one of the SRS intervals 711), or a periodicity and/or period associated with SRS instances, may be specified in terms of symbols. Diagram 700 illustrates that an SRS interval (e.g., each of the SRS intervals 711 and the SRS interval+extra CP 715) may be specified as 4 symbols and may include one of a first, second, third, or fourth symbol after a half subframe (e.g., in a fourth symbol of slot 723 after the end of the half subframe 703, or after a symbol including the extra CP 722 between the slot 721 and the slot 723).

As illustrated a first set of SRS intervals (e.g., the SRS intervals 711) may be uniform between SRS instances within a (same) half subframe. However, the interval between SRS instances in different half subframes may be separated by the SRS interval (e.g., 4 symbols) and the length of the extra CP (e.g., by the SRS interval+extra CP 715). Accordingly, the set of SRS instances over an SRS CPI that is longer than a half subframe (e.g., longer than 0.5 ms) may experience degradation of a DFT-based velocity estimation due to the non-uniform SRS intervals illustrated in diagram 700.

In some aspects, the Doppler estimation may still be possible but may be associated with a more complicated algorithm that may still not produce results that are as accurate as Doppler estimation based on uniform intervals between SRS instances. Accordingly, if an interval (e.g., an SRS interval) between SRS instances is constant/equal for different SRS instances, a first processing of the SRS instances may be used for velocity determination, while for unequal intervals between the SRS instances, a second, more sophisticated and/or more complicated processing of the SRS instances may be used for velocity determination. The decision to use one of equal, or unequal, intervals may be based on balancing the complexity of processing the SRS instances and a complexity of maintaining acceptable overhead to support system capacity for sensing while minimizing impact to communication performance.

In some aspects, to avoid the problems associated with non-uniform SRS transmission intervals, SRS instances may be transmitted with a symbol interval of 0.5 ms (or integer multiple of 0.5 ms). However, using such a large interval, in some aspects, may decrease the maximum detectable Doppler shift used in estimation (e.g., decrease a maximum detectable velocity). Such decreased maximum detectable velocity, in some aspects, may not be sufficient for automotive sensing (e.g., may not be able to detect a full range of velocities specified for automotive sensing). Additionally, or alternatively, to avoid the problems associated with non-uniform SRS transmission intervals, in some aspects, each SRS transmission (e.g., set of SRS instances associated with a sensing operation) may be limited to 0.5 ms. However, limiting the length of the SRS transmission may decrease a detectable resolution of the Doppler shift for the sensing operation (e.g., decrease a velocity resolution). As for the decreased maximum detectable velocity, a decreased velocity resolution may not be sufficient for automotive sensing (e.g., may not be able to detect velocity with a resolution specified for automotive sensing). Accordingly, some aspects disclosed herein, relate to a CP-length configuration for sensing that allows for uniform SRS instance intervals over a sufficient amount of time for detecting a full range of velocities with a resolution specified for automotive sensing.

For example, in some aspects, a wireless device may transmit an SRS using a first CP-length configuration, where the first CP-length configuration is different from a second CP-length configuration associated with communication. The wireless device, in a monostatic mode of operation, may receive a reflected SRS based on transmitting the SRS and may calculate at least one value associated with a corresponding at least one object in an environment of the wireless device based on the SRS and the reflected SRS. In a bistatic mode of operation, a base station, or other wireless device, may receive the reflected SRS using the first CP-length configuration and calculating at least one value associated with a corresponding at least one object in an environment of the wireless device based on the SRS and the reflected SRS. The base station, or other wireless device, may transmit, and the wireless device transmitting the SRS may receive, an indication of the at least one value. The SRS may include a set of SRS instances with a first periodicity (e.g., an interval in time between SRS instances or a number of symbols between SRS instances) over multiple slots and/or ms, where the first CP-length configuration is configured to maintain equal intervals in time based on a number of symbols between SRS instances.

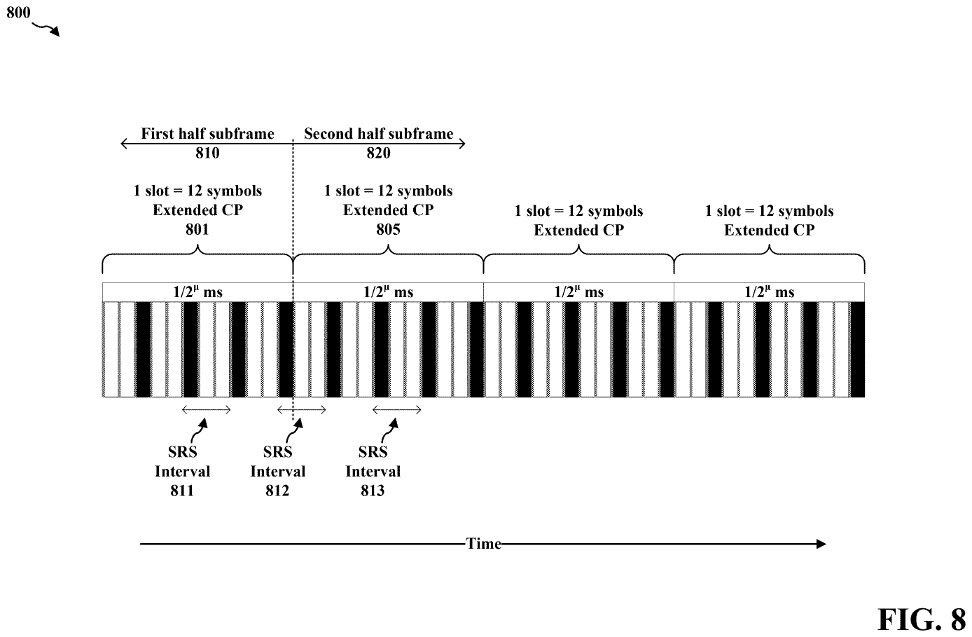

FIG. 8 includes a diagram 800 illustrating a CP configuration associated with equal-length CP for each symbol in a modified slot structure associated with at least an SRS CPI in accordance with some aspects of the disclosure. As described above, an ECP associated with a modified slot structure including 12 symbols per slot instead of 14 and equal length CP associated with each symbol is defined and/or supported for a 60 kHz SCS (e.g., a numerology, μ, of 2). However, for sensing signal transmission in a higher frequency band (e.g., in a mmWave band/FR2 from 24.25 GHz-52.6 GHz), there may be benefit to using a larger SCS. For example, sensing signal transmission may use 120 or 240 kHz SCS (e.g., a numerology, μ, of 3 or 4). Accordingly, diagram 800 illustrates a first CP-length configuration (alternatively referred to as a sensing CP configuration or an extended ECP (eECP) configuration) that may be used to extend the existing ECP to additional (higher) numerologies for sensing applications. Diagram 800 illustrates that a first slot 801 (of duration ½″ ms determined based on the numerology, μ) may be included in a first half subframe 810 associated with an SRS CPI. A second slot 805 may be included in a second half subframe 820 associated with the SRS CPI and adjacent to the first half subframe 810. The first slot 801 and the second slot 805 may include a set of SRS instances of the SRS CPI with an SRS interval of 3 symbols. As illustrated, because each CP is of equal length and there is no extra CP added at the beginning of a half subframe (as was the case for the configuration including an NCP of FIGS. 6 and 7), the SRS interval 811, the SRS interval 812, and the SRS interval 813 are all equal even though the SRS interval 812 includes a “border” between the first half subframe 810 and the second half subframe 820.

The configuration (e.g., the CP-length configuration) illustrated in diagram 800, in some aspects, may be dedicated, configured, or indicated for a resource pool or a BWP allocated for, or associated with, sensing signal transmissions (the SRS or other sensing signals for which uniform timing is beneficial). In some aspects, the resource pool or the BWP allocated for, or associated with, sensing signal transmissions (e.g., a dedicated resource pool/BWP or a sensing resource pool/BWP) may be configured by a base station (or other network device or network entity) to use the ECP (e.g., to use the eECP for SCS other than 60 kHz, or to use the first CP-length configuration illustrated in diagram 800). Accordingly, in some aspects, sensing signal transmissions (e.g., an SRS transmission or transmissions of other sensing signals) may be scheduled in the dedicated resource pool or BWP, while resources not in the dedicated (sensing) resource pool or BWP may be used for communication. Alternatively, or additionally, a base station (or other network device or network entity) may allocate (sensing signal) resources for a specific sensing signal transmission (from a specific wireless device) and may ensure that the ECP is used for the specific sensing signal transmission. For example, the base station may explicitly indicate the ECP in the grant or the configuration for the allocated sensing signal resources.

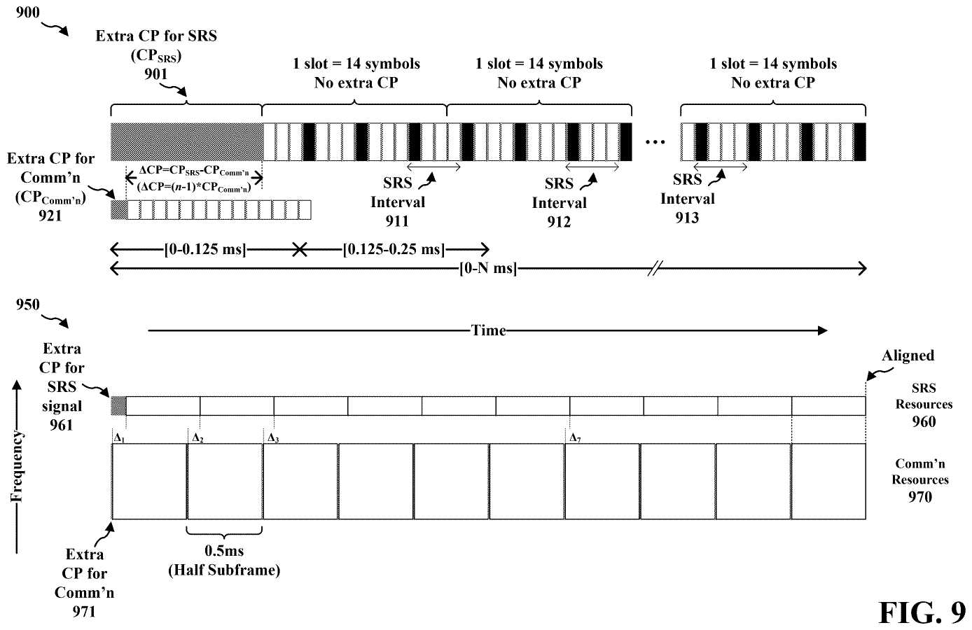

FIG. 9 includes a first diagram 900 illustrating a CP configuration associated with NCP for each symbol in a modified subframe and/or frame structure associated with at least an SRS CPI and a second diagram 950 illustrating a first set of frequency resources associated with sensing signal transmissions and a second set of frequency resources associated with communication transmissions in accordance with some aspects of the disclosure. Diagram 900 illustrates that for a set of resources associated with sensing signal transmissions, an extra CP for SRS 901 (CP_{SRS}) may be added at the beginning of a first time period for sensing signal transmissions. The extra CP for SRS 901 may be an integer multiple (e.g., n=N/0.5) of an extra CP for communication 921 based on the length of the set of resources associated with sensing signal transmissions. The length of the set of resources associated with sensing signal transmissions, in some aspects, may be associated with a minimum duration for a sensing signal transmission (e.g., an SRS CPI) to achieve a specified resolution of a value associated with the sensing signal transmission. The length of the set of resources associated with sensing signal transmissions may extend beyond the minimum duration to allow for SRS CPIs to start at times other than the beginning of the set of resources.

Diagram 950 illustrates a first set of resources (a resource pool or BWP) allocated for, or associated with, sensing signal transmission (e.g., the SRS resources 960) and a second set of resources associated with communication (e.g., the communication resources 970). In some aspects, the SRS resources 960 and the communication resources 970 may, for an SRS CPI, span 5 ms, or 10 half subframes, which may be a minimum duration for an SRS to achieve a velocity resolution of 1 m/s. Accordingly, the extra CP for SRS 901 (CP_{SRS}) and the CP for SRS 961 may be 10 times the length of the extra CP for communication 971 associated with the communication resources 970 to match the total length of the extra CP added over the 10 OFDM symbols (at the beginning of half subframes) in the 5 ms time period spanned by the SRS resources 960 and the communication resources 970. As illustrated in diagrams 900 and 950, the extra CP samples for SRS 901 or 961 may be concentrated in the first OFDM symbol of a first slot of a set of resources spanning 5 ms. For example, the first OFDM symbol of a first slot in the 5 ms time period spanned by the SRS resources 960 may have an extra-long CP while the remaining symbols in the 5 ms time period (or, in other aspects, a longer time period) spanned by the SRS resources 960 may have equal CP (or an NCP). Based on the remaining symbols having an equal CP, an SRS interval and/or SRS instance periodicity specified in terms of symbols may result in uniform spacing of SRS instances in time (e.g., a uniform SRS interval) as shown for SRS interval 911, SRS interval 912, and SRS interval 913 during an SRS CPI.

The concentration of the extra CP samples in the first OFDM symbol of the first slot may lead to a misalignment (e.g., Δᵢ for i∈[1,10]) between the beginning of a first symbol of a first slot of a half-subframe associated with the SRS resources 960 and the beginning of a corresponding first symbol of a first slot of a half subframe associated with the communication resources 970. In some aspects, by maintaining, allocating, specifying, identifying, and/or configuring separate resource pools or BWPs, the misalignment between half subframes, slots, and/or symbols of the SRS resources 960 and of the communication resources 970 may not lead to interference between sensing signal transmissions and communication transmissions. When using resource pools in a BWP also used for communication, in some aspects, the resource pool may be configured to align with the communication resources at the beginning and end of the allocated resource pool. In some aspects, the length of the set of resources associated with sensing signal transmissions may extend beyond the minimum duration, e.g., may span a 10 ms time period corresponding to a radio frame, to allow for SRS CPIs to start at times other than the beginning of the set of resources.

In some aspects, the SRS resources 960 may be allocated for a particular wireless device (e.g., a particular UE or vehicular UE) and/or for a particular SRS transmission (e.g., a set of SRS instances during an SRS CPI). As discussed above, the CP configuration (sometimes referred to as a sensing CP configuration, a sensing CP-length configuration, or a CP-length configuration for sensing signal transmissions) associated with diagram 900 and/or 950 may be associated with a resource pool, or BWP, (e.g., a dedicated, configured, or allocated resource pool or BWP configured for sensing signal transmission) during, or for, which SRS transmissions may be scheduled. For example, the resource pool or BWP may be resources configured and/or allocated by a base station or network device periodically (e.g., with a configured period). In each period, for example, there may be a number of slots/symbols configured for the resource pool or BWP associated with the sensing signal transmissions where the first symbol (or the first symbol of the first slot) of the resource pool or BWP in each period may have extra-long CP while the remaining symbols of the resource pool or BWP in that period may have equal CP lengths (e.g., an NCP). In some aspects, the SRS instances may be transmitted using an FMCW within the dedicated resources. For example, diagram 950 may represent (with exaggerated CP length) a symbol and/or slot structure associated with a 120 kHz SCS, a sampling rate of 491.52 MHz with 4096 FFT (e.g., 4096 samples per symbol) where a number of extra CP samples (e.g., the extra CP for communication 921 or the extra CP for communication 971) in a first OFDM symbol of each 0.5 ms duration may be 256 samples for a communication resource, or CP, configuration and for the SRS resource, or CP, configuration extra CP samples (e.g., extra CP for SRS 901 or extra CP for SRS 961) may be concentrated to a first symbol of the SRS resources (e.g., the SRS resources 960 for an SRS transmission) with the duration of 5 ms, such that the first symbol of the SRS resources may have 2560 extra CP samples.

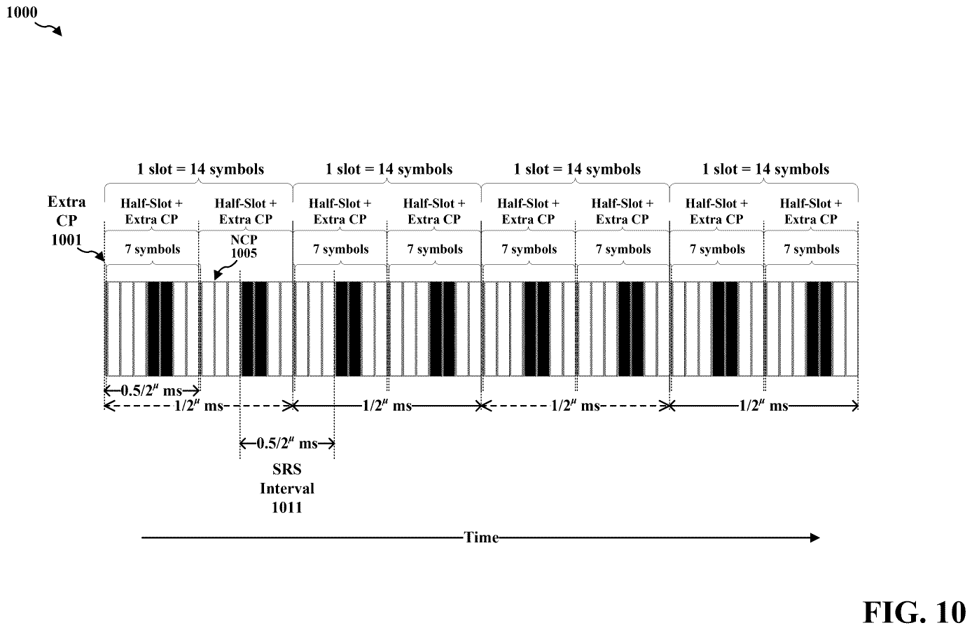

FIG. 10 is a diagram 1000 illustrating a CP configuration associated with additional CP samples added to a first symbol in each half slot in a modified slot structure associated with at least an SRS CPI in accordance with some aspects of the disclosure. For a sensing signal transmission, extra CP samples may be distributed among multiple OFDM symbols within each 0.5 ms duration (within each half-subframe). For example, extra CP samples (e.g., extra CP 1001) may be distributed to a first symbol of every half slot (e.g., where a half slot includes 7 OFDM symbols in NR). Other symbols associated with the SRS CPI may be associated with an NCP 1005 (e.g., 288 samples). As illustrated in diagram 1000, for a numerology, u, a half slot including 7 symbols may be configured with an extra CP 1001 and may span a time 0.5/2^{μ} ms (one-half of a slot length of 1/2^{μ}ms).

Diagram 1000 further illustrates that, in some aspects, the SRS instances associated with an SRS transmission may be multi-symbol SRS instances (e.g., the SRS instances associated with the SRS transmissions and CP configurations of FIGS. 8 and 9 may alternatively be multi-symbol SRS instances, while the SRS instances of diagram 1000 may be single-symbols SRS instances in some aspects). In some aspects distributing the extra CP sample among the first symbols of half slots of the half subframe as illustrated in diagram 1000, the SRS interval (e.g., the SRS interval 1011) may be a half slot (e.g., 7 symbols). In some aspects, diagram 1000 may represent (with exaggerated CP length) a symbol and/or slot structure associated with a 120 kHz SCS (e.g., μ=3) and a sampling rate of 491.52 MHz with 4096 FFT (e.g., 4096 samples per symbol), where a number of extra CP samples (e.g., the extra CP 1001) in a first OFDM symbol of each half slot for the SRS resource (or CP) configuration may be 32 samples. For higher numerologies, the distribution of the extra CP samples may be over a different set of symbols in a half subframe, e.g., a first symbol of each slot, or over a first symbol of every n^{th} slot for even values of n selected to ensure that the extra CP samples are able to be distributed equally among the set of symbols. Additionally, or alternatively, the set of symbols including, or associated with, the extra CP samples may be configured such that the periodicity of the extra CP sample insertion and/or addition is less than a maximum SRS (or sensing signal) interval for achieving a specified resolution or range for a sensing operation. For example, if a specified resolution or range of a sensing operation is associated with an SRS interval that is, at most, 0.2 ms, the extra CP may be inserted every 2^{μ-}3 slots (or as often as every half slot as illustrated in diagram 1000) for numerologies 2 and above. Alternatively, if the specified resolution or range of the sensing operation is associated with an SRS interval that is, at most, 0.4 ms, the extra CP may be inserted every 2^{μ-}2 slots (or as often as every half slot as illustrated in diagram 1000) for numerologies 1 and above. If, as described in relation to FIG. 9, the alignment is based on an SRS CPI, the periodicity of the insertion/addition of the extra CP samples may be capable of taking on additional values limited by the condition that the extra CP samples be able to divided equally among the symbols of the SRS CPI associated with the extra CP samples and that the periodicity (or period) of the insertion/addition is not greater than the maximum SRS (or sensing signal) interval for achieving the specified resolution or range for a sensing operation.

The configuration (e.g., the CP-length configuration) illustrated in diagram 1000, in some aspects, may be dedicated, configured, or indicated for a resource pool or a BWP allocated for, or associated with, sensing signal transmissions (the SRS or other sensing signals for which uniform timing is beneficial). In some aspects, the resource pool or the BWP allocated for, or associated with, sensing signal transmissions (e.g., a dedicated resource pool or BWP or a sensing resource pool or BWP) may be configured by a base station (or other network device or network entity) to use the CP configuration (sometimes referred to as a sensing CP configuration, a sensing CP-length configuration, or a CP-length configuration for sensing signal transmissions) illustrated in diagram 1000. Accordingly, in some aspects, sensing signal transmissions (e.g., an SRS transmission or transmissions of other sensing signals) may be scheduled in the dedicated resource pool or BWP, while resources not in the dedicated (sensing) resource pool or BWP may be used for communication as described in relation to diagram 950 of FIG. 9 and the SRS resources 960 and the communication resources 970. Alternatively, or additionally, a base station (or other network device or network entity) may allocate (sensing signal) resources for a specific sensing signal transmission (from a specific wireless device) and may ensure that the CP configuration illustrated in diagram 1000 is used for the specific sensing signal transmission. For example, the base station may explicitly indicate the CP configuration in the grant (e.g., in a DCI) or the configuration for the allocated sensing signal resources.

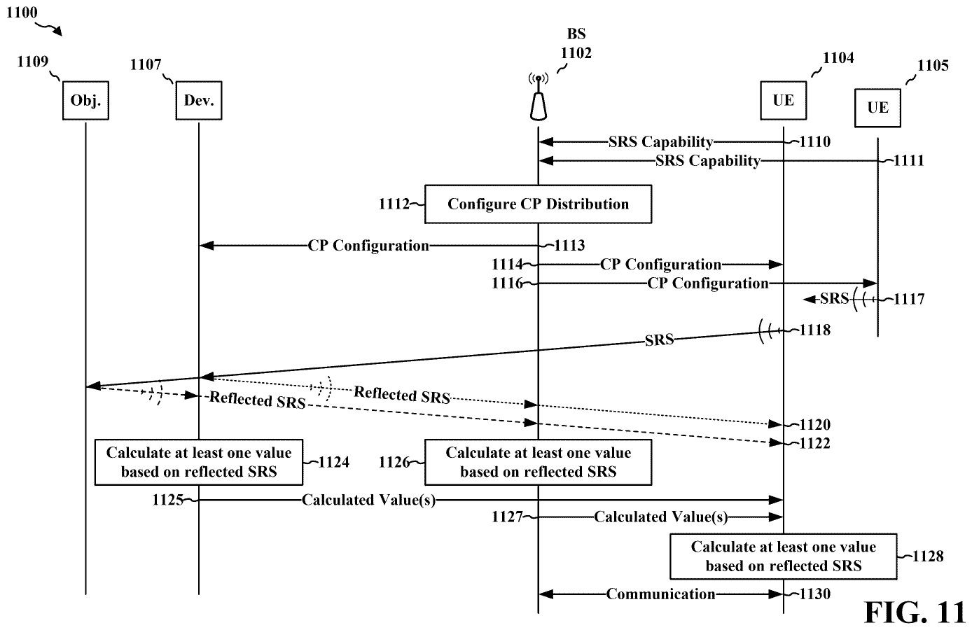

FIG. 11 is a call flow diagram 1100 illustrating a UE 1104 performing sensing and communication operations in accordance with some aspects of the disclosure. The environment of the UE 1104 may include a UE 1105, a base station 1102, a device 1107, and an object 1109 that may be detected by a sensing operation. In some aspects, the UE 1104 may be a vehicle UE or may be associated with or located at a vehicle, and the device 1107 may be an additional UE, which may be associated with, a component of, or located at a vehicle. In such an example, the object 1109 may be an obstruction, road hazard, pedestrian, etc. In other aspects, the sensing and communication may be applied by a UE in non-vehicular applications. In some aspects, the UE 1104 (as an example of a UE or wireless device configured for communication and sensing) may transmit, and a base station 1102 (as an example of a network device configuring and/or allocating resources for a set of associated wireless devices) may receive, an SRS capability indication 1110 that indicates that the UE 1104 (e.g., the wireless device) does not support (or is not configured to perform) a sensing operation based on unequally-spaced SRS instances (e.g., non-uniform SRS intervals). Similarly, a UE 1105 may transmit, and the base station 1102 may receive, an SRS capability indication 1111 that indicates whether the UE 1105 (e.g., the wireless device) supports (or is configured to perform) sensing operations based on unequally-spaced SRS instances (e.g., non-uniform SRS intervals). For example, the UE 1105 may employ more sophisticated algorithms for Doppler/velocity estimation and may, accordingly, support a sensing operation based on unequally-spaced SRS instances or non-uniform SRS intervals. The UE 1105 may, in some aspects, indicate the support for non-uniform SRS intervals in the SRS capability indication 1111 and the base station 1102 may be able to schedule or allocate resources for a sensing operation (e.g., for an SRS transmission) via resources using a CP (or CP-length) configuration that does not ensure equally-spaced SRS instances (e.g., via communication resources associated with extra CP samples added every half subframe as described in relation to FIGS. 6 and 7).

Based on the SRS capability indication 1110 and/or the SRS capability indication 1111, the base station 1102 (or a network entity associated with base station 1102) may configure, at 1112, a (first) CP-length configuration for the UE 1104 (and, in some aspects, a (third) CP-length configuration for the UE 1105) associated with a distribution of CP among subframes, half subframes, slots, and/or symbols associated with sensing signal transmissions (e.g., one of the CP configurations described in relation to FIGS. 8-10). For example, if at least one wireless device (e.g., the UE 1104 or the UE 1105) indicates that it does not support sensing operations based on non-uniform SRS intervals, the base station 1102 may configure the CP-length configuration for sensing signal transmissions. The base station 1102, in some aspects, may configure the CP-length configuration at 1112 for one or more particular SRS transmissions (e.g., one or more sets of SRS instances each spanning an SRS CPI) for one or more corresponding wireless devices.

The base station 1102, in some aspects, may configure the CP-length configuration at 1112 for a resource pool or BWP for subsequent allocation to, or scheduling for, wireless devices performing sensing operations (e.g., via SRS transmissions). In some aspects, the base station 1102 may configure the resources for sensing signal transmission with the (first) CP-length configuration as a cell-specific configuration or as a group-common configuration while maintaining a different (second) CP-length configuration for communication resources. In some aspects, because of the different distribution of extra CP among the subframes, half subframes, slots, and/or symbols associated with sensing signal transmissions there may be a misalignment (or mismatch) of CP between transmissions (e.g., communications (DL or UL communication such as PDSCH or PUSCH) and sensing signal transmissions) associated with different wireless devices (e.g., UEs capable of using non-uniform SRS intervals or UEs communicating using a CP-length configuration for communication and UEs transmitting SRS instances using a CP-length configuration for sensing signal transmissions). A base station 1102 (e.g., a scheduler), in some aspects, may avoid overlapping transmissions based on the misalignment by allocating resources that do not overlap (e.g., for the CP configuration illustrated in FIG. 9, the base station may only schedule communications via symbols that overlap with only the 3 symbols between SRS instances but not the symbols used for the SRS instances).

In some aspects, e.g., the CP configuration illustrated in FIG. 10, the misalignment may be within a CP length such that the misalignment may not lead to unacceptable overlap (e.g., an unacceptable overlap such that there are less than the number of data samples associated with a symbol, e.g., 4096 in some of the examples discussed above, that do not overlap with an adjacent symbol used to transmit an SRS instance). For example, the sensing CP configuration illustrated in FIG. 10 may be associated with 32 extra CP samples at the beginning of a half subframe while a communication CP configuration may be associated with 256 extra CP samples at the beginning of a half subframe. This difference between the length of the extra CP added at the beginning of a half subframe may result in a (maximum) misalignment between a first symbol of the sensing CP configuration and the communication CP configuration of 214 samples which is within the 288 samples of CP associated with each subsequent symbol, with the misalignment being reduced, e.g., by 32 samples, as the extra CP samples (e.g., extra CP 1001) are added every half slot for the sensing CP configuration but not for the communication CP configuration.

Based on the (first) CP-length configuration configured at 1112, the base station 1102 may transmit, and the UE 1104 may receive, a CP configuration indication 1114 indicating one or more CP-length configurations associated with an SRS transmission, a dedicated/sensing resource pool, or a dedicated/sensing BWP. Similarly, the base station 1102 may transmit, and the UE 1105 and device 1107 may receive, a CP configuration indication 1116 and a CP configuration indication 1113, respectively, indicating the one or more CP-length configurations associated with an SRS transmission, the dedicated/sensing resource pool, or the dedicated/sensing BWP. In some aspects, the CP configuration indication 1113 or 1116 may be transmitted to the device 1107 or the UE 1105 even if the SRS capability indication 1111 (or a similar SRS capability indication received from the device 1107) indicates that the UE 1105 (or device 1107) supports non-uniform SRS intervals, to allow the UE 1105 and the device 1107 to participate (e.g., as a receiver) in a bistatic sensing operation. In some aspects, the CP configuration indication 1114 may be associated with a cell-specific configuration (e.g., configured via a SIB) signaling or may be associated with a group-common configuration signaling. The CP configuration indication 1114, in some aspects, may include the (first) CP-length configuration to be used for an indicated sensing resource pool or sensing BWP, while applying a different (second) CP-length configuration for communication resources. In some aspects, the CP configuration indication 1113, the CP configuration indication 1114, and/or the CP configuration indication 1116 may be transmitted via one or more of RRC signaling (layer 3 signaling), a MAC-CE (e.g., layer 2 signaling), or DCI (e.g., layer 1 signaling). For example, a dedicated set of sensing signal resources (e.g., a periodic resource pool or a BWP) may be configured via RRC signaling and a particular SRS transmission may be scheduled within the configured set of sensing signal resources. Alternatively, or additionally, a plurality of candidate sets of sensing signal resources may be configured via RRC signaling, a particular candidate set of sensing signal resources may be activated via a MAC-CE, and a particular SRS transmission may be scheduled within the configured set of sensing signal resources. While two examples of using signaling associated with different layers have been discussed, other combinations of layer 3, layer 2, and layer 1 signaling and/or signals may be used in some aspects.

Based on the CP configuration indication 1114 and 1116, the UE 1104 and the UE 1105 may transmit SRS transmission 1118 and SRS transmission 1117, respectively. The SRS transmission 1118, in some aspects, may use an FMCW waveform as described in relation to FIG. 4. Alternatively, or additionally, the SRS transmission 1118, in some aspects, may use a DFT-s-OFDM or filter bank multi-carrier (FBMC) waveform (or modulation scheme). The SRS transmission 1118, in some aspects, may be reflected from the device 1107 and the object 1109 as reflected SRS 1120 and reflected SRS 1122, respectively. The reflected SRS 1120, in some aspects, may be received at each of the base station 1102 and the UE 1104, while the reflected SRS 1122 may be received at each of the device 1107, the base station 1102, and the UE 1104. Each device receiving a reflected SRS, in some aspect, may calculate at a least one value associated with the object from which the SRS transmission 1118 was reflected. Accordingly, the UE 1104 and the base station 1102 may calculate, at 1128 and 1126, respectively, at least one value (e.g., a velocity, a relative velocity, and/or distance) associated with the device 1107 and the object 1109 based on the SRS transmission 1118 (e.g., based on knowledge of the CP-length configuration configured at 1112 and indicated by the CP configuration indication 1114 associated with the SRS transmission 1118) and the reflected SRS 1120 and 1122, respectively. Similarly, the device 1107 may calculate, at 1124, at least one value (e.g., a velocity, a relative velocity, and/or distance) associated with the object 1109 based on the SRS transmission 1118 (e.g., based on knowledge of the CP-length configuration configured at 1112 and indicated by the CP configuration indication 1113 associated with the SRS transmission 1118) and the reflected SRS 1122. Based on the at least one value calculated at 1124 or 1126, the device 1107 or the base station 1102 may transmit, and UE 1104 may receive, (an indication of) the calculated value(s) 1125 or the calculated value(s) 1127, respectively. In some aspects, calculating the at least one value at 1128 may additionally be based on the calculated value(s) 1125 and 1127 and may involve a synthesis of at least one value calculated locally based on the reflected SRS 1120 and the reflected SRS 1122 and the calculated value(s) 1125 and/or 1127 received from the device 1107 and/or the base station 1102 to determine, calculate, or estimate the at least one value associated with each detected object. In addition to the sensing operation associated with the SRS transmission 1118, the UE 1104 may support, or be configured for, communication with the base station 1102. Accordingly, the UE 1104 may transmit (and/or receive), and base station 1102 may receive (and/or transmit), communication 1130 using a CP configuration associated with communication (e.g., with a communication resource or communication BWP).

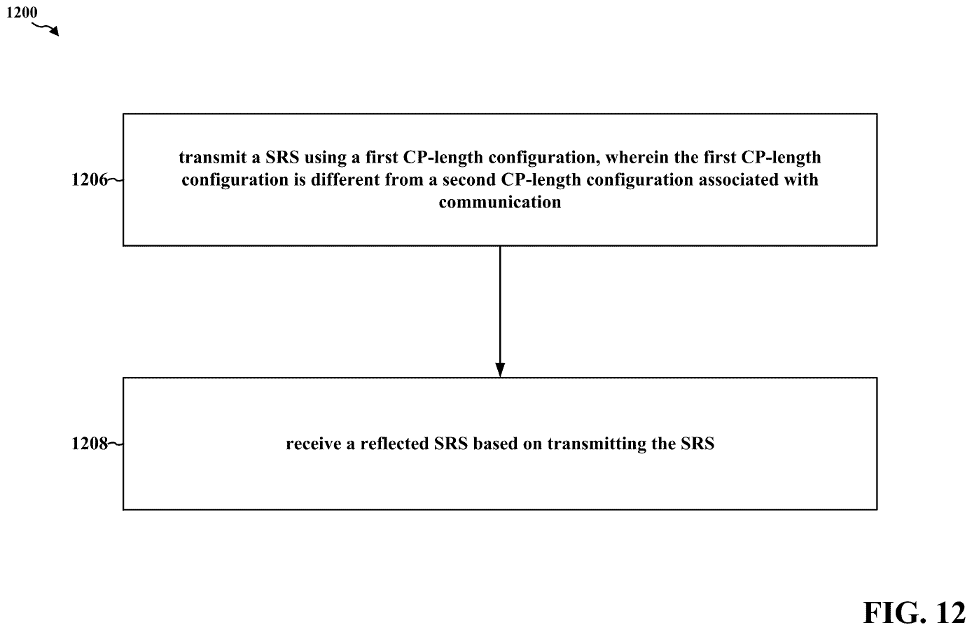

FIG. 12 is a flowchart 1200 of a method of wireless communication associated with a sensing operation. The method may be performed by a UE or wireless device such as a vehicular UE or other wireless device configured for sensing operations and communication (e.g., the UE 104 or 1104; the vehicular UE 504; the apparatus 1704). In some aspects, the UE may receive, from a network device, a first indication of a first CP-length configuration. In some aspects, the network device may be one of a base station, a network entity, or an additional wireless device (e.g., another UE communicating with the UE via SL) associated with the UE that configures the first CP-length configuration. The first CP-length configuration may be associated with one or more particular SRS transmissions (e.g., one or more sets of SRS instances each spanning an SRS CPI) for the UE or may be associated with a resource pool or BWP for subsequent allocation to, or scheduling for, wireless devices performing sensing operations (e.g., via SRS transmissions). In some aspects, the first CP-length configuration may be one of a UE-specific configuration, a cell-specific configuration, or a group-common configuration. In some aspects, the first CP-length configuration associated with the SRS is different from a second CP-length configuration associated with communication. For example, referring to FIG. 11, the UE 1104 may receive, from the base station 1102, the CP configuration indication 1114 indicating a CP-length configuration associated with an SRS transmission, a dedicated/sensing resource pool, or a dedicated/sensing BWP.

The first CP-length configuration, in some aspects, may be configured to ensure that a set of SRS instances transmitted using, or associated with, the first CP-length configuration are equally-spaced in time during the SRS CPI. In some aspects, the first CP-length configuration includes an equal-length CP associated with each symbol of a CPI for the SRS that spans a plurality of slots. The first CP-length configuration, in some aspects, includes an ECP associated with the equal-length CP, and the second CP-length configuration includes an NCP. For example, referring to FIG. 8 the first CP-length configuration may specify a slot including 12 symbols each associated with an equal-length CP (e.g., an equal length CP including 1024 samples).

The first CP-length configuration, in some aspects, may be associated with a first CP including a first number of samples at a beginning of a CPI for the SRS (before a first symbol of the SRS) that is different from a second number of samples associated with a second CP included in, or associated with, subsequent symbols of the CPI. In some aspects, the first number of samples is based on a duration of the CPI for the SRS. For example, referring to FIG. 9, the first CP may correspond to the extra CP for SRS 901 (or CP_{SRS}) that may include a first number of samples that may be an integer multiple (e.g., n=N/0.5) of an extra CP for communication 921 based on the length N of the set of resources (or a periodicity 1/N of a set of periodic resources) associated with sensing signal transmissions (e.g., resources associated with the first CP-length configuration).

In some aspects, the first CP-length configuration may include a first CP configuration associated with a first number of samples and a second CP configuration associated with a second number of samples that is smaller than the first number of samples. The first CP configuration, in some aspects, may be associated with a first symbol in each half of each slot associated with the SRS (or the SRS CPI) and the second CP configuration may be associated with remaining symbols of each slot associated with the SRS (or the SRS CPI). In some aspects, the first CP configuration, may be associated with a first symbol in each half of each slot associated with the SRS (or the SRS CPI) and the second CP configuration may be associated with remaining symbols of each slot associated with the SRS (or the SRS CPI). In some aspects, first CP configuration, may be associated with a first symbol in each of a set of units including an integer number of half slots associated with the SRS (or the SRS CPI) and the second CP configuration may be associated with remaining symbols of each slot associated with the SRS (or the SRS CPI). For example, referring to FIG. 10, the first CP configuration may be associated with the first number of samples included in the extra CP 1001 and the second CP configuration may be associated with the second number of samples included in the NCP 1005.

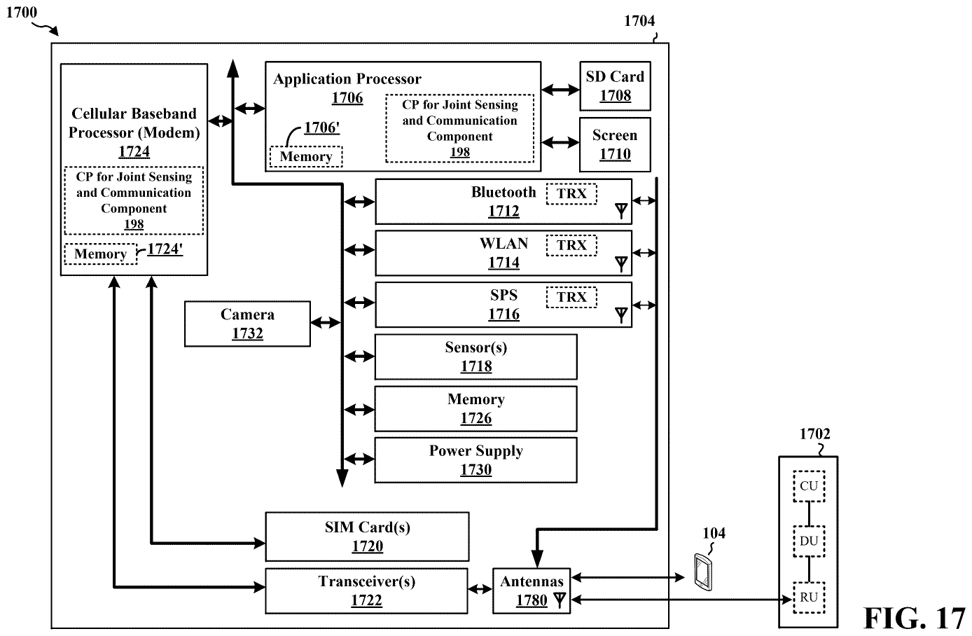

At 1206, the UE may transmit an SRS using the first CP-length configuration. For example, 1206 may be performed by application processor 1706, cellular baseband processor 1724, transceiver(s) 1722, antenna(s) 1780, and/or CP for joint sensing and communication component 198 of FIG. 17. In some aspects, the first CP-length configuration associated with the SRS is different from a second CP-length configuration associated with communication. The SRS, in some aspects, may be transmitted at 1206 using an FMCW. In some aspects, the SRS transmitted at 1206 includes a set of SRS instances associated with a first periodicity and spanning an SRS CPI including multiple slots. The SRS, in some aspects, may be transmitted via a resource pool dedicated, configured, or indicated for at least one SRS transmission, or a BWP dedicated, configured, or indicated for the at least one SRS transmission. For example, referring to FIGS. 9 and 11, the UE 1104 may transmit SRS transmission 1118 using the CP-length configuration associated with an SRS transmission based on the CP configuration indication 1114 via a dedicated/sensing resource pool, or a dedicated/sensing BWP, e.g., the SRS resources 960.

At 1208, the UE may receive a reflected SRS based on transmitting the SRS. For example, 1208 may be performed by application processor 1706, cellular baseband processor 1724, transceiver(s) 1722, antenna(s) 1780, and/or CP for joint sensing and communication component 198 of FIG. 17. The received reflected SRS, in some aspects, may be reflected from an object in the environment of the UE. For example, referring to FIG. 11, the UE 1104 may receive the reflected SRS 1120 and the reflected SRS 1122 based on the SRS transmission 1118 being reflected from device 1107 and object 1109, respectively.

In some aspects, the UE may also receive, based on the SRS, an indication of at least one value associated with a corresponding at least one object in an environment of the wireless device. The indication of the at least one value associated with the corresponding at least one object in an environment of the wireless device, in some aspects, may be received from another network device (e.g., a base station or sensing-capable UE) that receives reflections of the SRS transmitted at 1206 and, based on knowledge of the first CP-length configuration (and, in some aspects, the allocated resources for the SRS transmitted at 1206), calculates the at least one value associated with the corresponding at least one object based on the reflected SRS it receives that it then transmits to be received at the UE at 1210. For example, referring to FIG. 11, the UE 1104 may receive the calculated value(s) 1125 and 1127 regarding the device 1107 and the object 1109 from the device 1107 and the base station 1102, respectively, based on the SRS transmission 1118 (and the reflected SRS 1120 and the reflected SRS 1122).

Based on the reflected SRS (an, in some aspects, the indication of the at least one value associated with the corresponding at least one object in the environment of the wireless device), the UE may calculate at least one value associated with a corresponding at least one object in the environment of the wireless device based on the SRS and the reflected SRS. In some aspects, calculating the at least one value may include calculating at least one of a velocity, a relative velocity, a distance, and/or a relative position associated with the corresponding at least one object. The calculation, in some aspects, may be based on a Doppler shift in the frequencies of the reflected SRS. The calculation, in some aspects, may further be based on the indication of at least one value associated with a corresponding at least one object received from another network device. For example, referring to FIG. 11, the UE 1104 may calculate the at least one value at 1128, where calculating the at least one value may be based on the SRS transmission 1118, the reflected SRS 1120, and/or the reflected SRS 1122 and may further be based on the calculated value(s) 1125 and 1127 regarding the device 1107 and the object 1109 received from the device 1107 and the base station 1102, respectively.

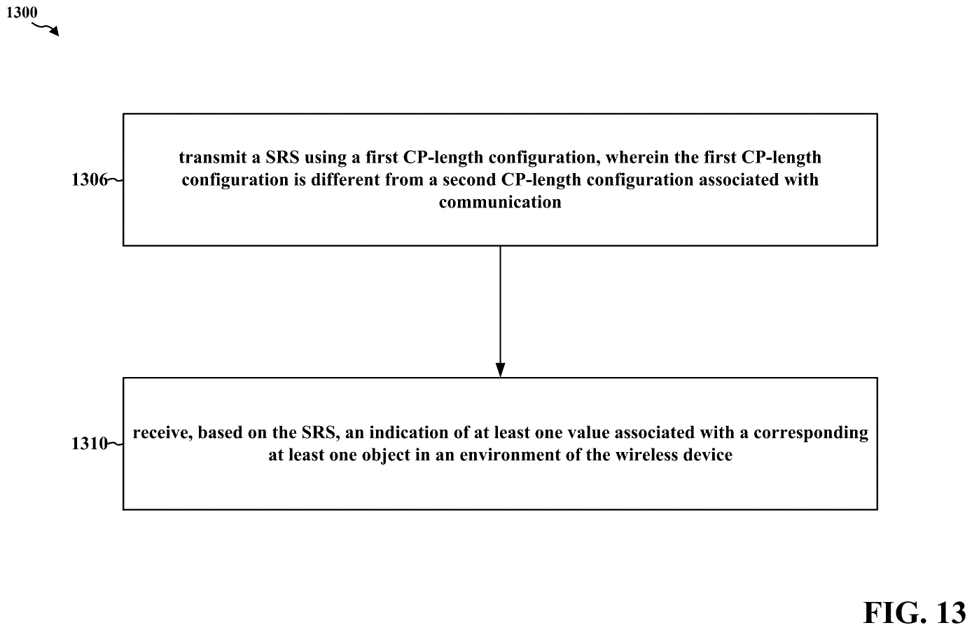

FIG. 13 is a flowchart 1300 of a method of wireless communication associated with a sensing operation. The method may be performed by a UE or wireless device such as a vehicular UE or other wireless device configured for sensing operations and communication (e.g., the UE 104 or 1104; the vehicular UE 504; the apparatus 1704). In some aspects, the UE may receive, from a network device, a first indication of a first CP-length configuration. In some aspects, the network device may be one of a base station, a network entity, or an additional wireless device (e.g., another UE communicating with the UE via SL) associated with the UE that configures the first CP-length configuration. The first CP-length configuration may be associated with one or more particular SRS transmissions (e.g., one or more sets of SRS instances each spanning an SRS CPI) for the UE or may be associated with a resource pool or BWP for subsequent allocation to, or scheduling for, wireless devices performing sensing operations (e.g., via SRS transmissions). In some aspects, the first CP-length configuration may be one of a UE-specific configuration, a cell-specific configuration, or a group-common configuration. In some aspects, the first CP-length configuration associated with the SRS is different from a second CP-length configuration associated with communication. For example, referring to FIG. 11, the UE 1104 may receive, from the base station 1102, the CP configuration indication 1114 indicating a CP-length configuration associated with an SRS transmission, a dedicated/sensing resource pool, or a dedicated/sensing BWP.

The first CP-length configuration, in some aspects, may be configured to ensure that a set of SRS instances transmitted using, or associated with, the first CP-length configuration are equally-spaced in time during the SRS CPI. In some aspects, the first CP-length configuration includes an equal-length CP associated with each symbol of a CPI for the SRS that spans a plurality of slots. The first CP-length configuration, in some aspects, includes an ECP associated with the equal-length CP, and the second CP-length configuration includes an NCP. For example, referring to FIG. 8 the first CP-length configuration may specify a slot including 12 symbols each associated with an equal-length CP (e.g., an equal length CP including 64 samples).

The first CP-length configuration, in some aspects, may be associated with a first CP including a first number of samples at a beginning of a CPI for the SRS (before a first symbol of the SRS) that is different from a second number of samples associated with a second CP included in, or associated with, subsequent symbols of the CPI. In some aspects, the first number of samples is based on a duration of the CPI for the SRS. For example, referring to FIG. 9, the first CP may correspond to the extra CP for SRS 901 (or CP_{SRS}) that may include a first number of samples that may be an integer multiple (e.g., n=N/0.5) of an extra CP for communication 921 based on the length N of the set of resources (or a periodicity 1/N of a set of periodic resources) associated with sensing signal transmissions (e.g., resources associated with the first CP-length configuration).

In some aspects, the first CP-length configuration may include a first CP configuration associated with a first number of samples and a second CP configuration associated with a second number of samples that is smaller than the first number of samples. The first CP configuration, in some aspects, may be associated with a first symbol in each half of each slot associated with the SRS (or the SRS CPI) and the second CP configuration may be associated with remaining symbols of each slot associated with the SRS (or the SRS CPI). In some aspects, the first CP configuration, may be associated with a first symbol in each half of each slot associated with the SRS (or the SRS CPI) and the second CP configuration may be associated with remaining symbols of each slot associated with the SRS (or the SRS CPI). In some aspects, first CP configuration, may be associated with a first symbol in each of a set of units including an integer number of half slots associated with the SRS (or the SRS CPI) and the second CP configuration may be associated with remaining symbols of each slot associated with the SRS (or the SRS CPI). For example, referring to FIG. 10, the first CP configuration may be associated with the first number of samples included in the extra CP 1001 and the second CP configuration may be associated with the second number of samples included in the NCP 1005.

At 1306, the UE may transmit an SRS using the first CP-length configuration. For example, 1306 may be performed by application processor 1706, cellular baseband processor 1724, transceiver(s) 1722, antenna(s) 1780, and/or CP for joint sensing and communication component 198 of FIG. 17. In some aspects, the first CP-length configuration associated with the SRS is different from a second CP-length configuration associated with communication. The SRS, in some aspects, may be transmitted at 1306 using an FMCW. In some aspects, the SRS transmitted at 1306 includes a set of SRS instances associated with a first periodicity and spanning an SRS CPI including multiple slots. The SRS, in some aspects, may be transmitted via a resource pool dedicated, configured, or indicated for at least one SRS transmission, or a BWP dedicated, configured, or indicated for the at least one SRS transmission. For example, referring to FIGS. 9 and 11, the UE 1104 may transmit SRS transmission 1118 using the CP-length configuration associated with an SRS transmission based on the CP configuration indication 1114 via a dedicated/sensing resource pool, or a dedicated/sensing BWP, e.g., the SRS resources 960.

At 1310, the UE may receive, based on the SRS, an indication of at least one value associated with a corresponding at least one object in an environment of the wireless device. For example, 1310 may be performed by application processor 1706, cellular baseband processor 1724, transceiver(s) 1722, antenna(s) 1780, and/or CP for joint sensing and communication component 198 of FIG. 17. In some aspects, the at least one value may include at least one of a velocity, a relative velocity, a distance, and/or a relative position associated with the corresponding at least one object. The indication of the at least one value associated with the corresponding at least one object in an environment of the wireless device, in some aspects, may be received from another network device (e.g., a base station or sensing-capable UE) that receives reflections of the SRS transmitted at 1306 and, based on knowledge of the first CP-length configuration (and, in some aspects, the allocated resources for the SRS transmitted at 1306), calculates the at least one value associated with the corresponding at least one object based on the reflected SRS it receives that it then transmits to be received at the UE at 1310. In some aspects, based on the received indication of the at least one value associated with the corresponding at least one object in the environment of the wireless device, the UE may calculate or estimate at least one of a velocity, a relative velocity, a distance, and/or a relative position associated with the corresponding at least one object. For example, referring to FIG. 11, the UE 1104 may receive the calculated value(s) 1125 and 1127 regarding the device 1107 and the object 1109 from the device 1107 and the base station 1102, respectively, based on the SRS transmission 1118 (and the reflected SRS 1120 and the reflected SRS 1122) and may calculate at 1128 the at least one value based on the calculated value(s) 1125 and 1127.

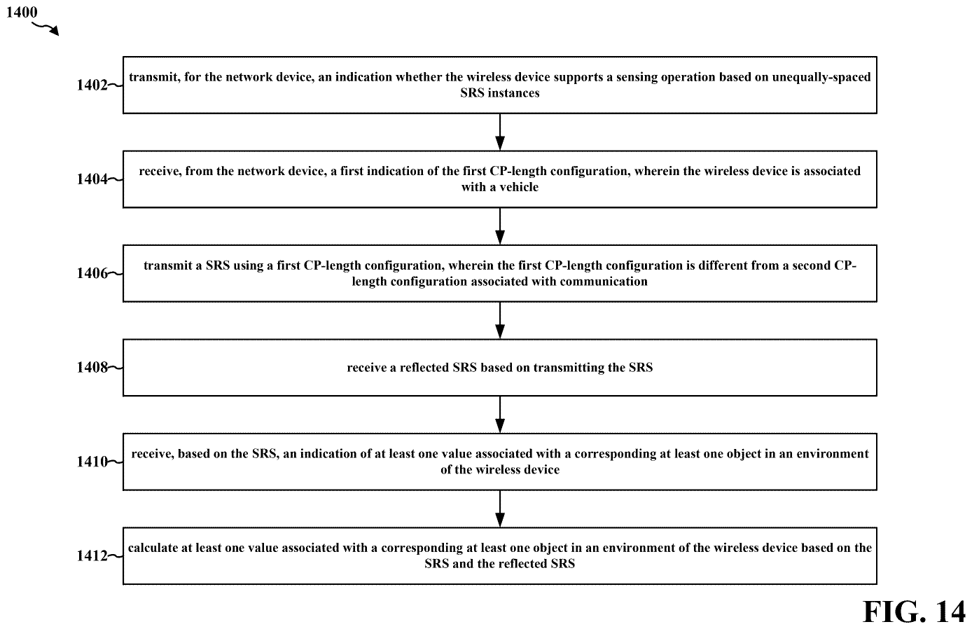

FIG. 14 is a flowchart 1400 of a method of wireless communication associated with a sensing operation. The method may be performed by a UE or wireless device such as a vehicular UE or other wireless device configured for sensing operations and communication (e.g., the UE 104 or 1104; the vehicular UE 504; the apparatus 1704). At 1402, the UE may transmit, for a network device, a capability indication whether the wireless device supports (or is configured to perform) a sensing operation based on unequally-spaced SRS instances. For example, 1402 may be performed by application processor 1706, cellular baseband processor 1724, transceiver(s) 1722, antenna(s) 1780, and/or CP for joint sensing and communication component 198 of FIG. 17. The indication may indicate that the wireless device does not support the sensing operation based on unequally-spaced SRS instances. For example, the UE, in some aspects, may not be configured to perform a more complicated processing associated with unequally-spaced SRS instances (or non-uniform SRS intervals). For example, referring to FIG. 11, the UE 1104 may transmit, and the base station 1102 may receive, the SRS capability indication 1110 that indicates that the UE 1104 (e.g., the wireless device) does not support (or is not configured to perform) a sensing operation based on unequally-spaced SRS instances (e.g., non-uniform SRS intervals).

At 1404, the UE may receive, from the network device, a first indication of a first CP-length configuration. For example, 1404 may be performed by application processor 1706, cellular baseband processor 1724, transceiver(s) 1722, antenna(s) 1780, and/or CP for joint sensing and communication component 198 of FIG. 17. In some aspects, the network device may be one of a base station, a network entity, or an additional wireless device (e.g., another UE communicating with the UE via SL) associated with the UE that configures the first CP-length configuration. The first CP-length configuration may be associated with one or more particular SRS transmissions (e.g., one or more sets of SRS instances each spanning an SRS CPI) for the UE or may be associated with a resource pool or BWP for subsequent allocation to, or scheduling for, wireless devices performing sensing operations (e.g., via SRS transmissions). In some aspects, the first CP-length configuration may be one of a UE-specific configuration, a cell-specific configuration, or a group-common configuration. In some aspects, the first CP-length configuration associated with the SRS is different from a second CP-length configuration associated with communication. For example, referring to FIG. 11, the UE 1104 may receive, from the base station 1102, the CP configuration indication 1114 indicating a CP-length configuration associated with an SRS transmission, a dedicated/sensing resource pool, or a dedicated/sensing BWP.

The first CP-length configuration, in some aspects, may be configured to ensure that a set of SRS instances transmitted using, or associated with, the first CP-length configuration are equally-spaced in time during the SRS CPI. In some aspects, the first CP-length configuration includes an equal-length CP associated with each symbol of a CPI for the SRS that spans a plurality of slots. The first CP-length configuration, in some aspects, includes an ECP associated with the equal-length CP, and the second CP-length configuration includes an NCP. For example, referring to FIG. 8 the first CP-length configuration may specify a slot including 12 symbols each associated with an equal-length CP (e.g., an equal length CP including 1024 samples).

The first CP-length configuration, in some aspects, may be associated with a first CP including a first number of samples at a beginning of a CPI for the SRS (before a first symbol of the SRS) that is different from a second number of samples associated with a second CP included in, or associated with, subsequent symbols of the CPI. In some aspects, the first number of samples is based on a duration of the CPI for the SRS. For example, referring to FIG. 9, the first CP may correspond to the extra CP for SRS 901 (or CP_{SRS}) that may include a first number of samples that may be an integer multiple (e.g., n=N/0.5) of an extra CP for communication 921 based on the length N of the set of resources (or a periodicity 1/N of a set of periodic resources) associated with sensing signal transmissions (e.g., resources associated with the first CP-length configuration).

In some aspects, the first CP-length configuration may include a first CP configuration associated with a first number of samples and a second CP configuration associated with a second number of samples that is smaller than the first number of samples. The first CP configuration, in some aspects, may be associated with a first symbol in each half of each slot associated with the SRS (or the SRS CPI) and the second CP configuration may be associated with remaining symbols of each slot associated with the SRS (or the SRS CPI). In some aspects, the first CP configuration, may be associated with a first symbol in each half of each slot associated with the SRS (or the SRS CPI) and the second CP configuration may be associated with remaining symbols of each slot associated with the SRS (or the SRS CPI). In some aspects, first CP configuration, may be associated with a first symbol in each of a set of units including an integer number of half slots associated with the SRS (or the SRS CPI) and the second CP configuration may be associated with remaining symbols of each slot associated with the SRS (or the SRS CPI). For example, referring to FIG. 10, the first CP configuration may be associated with the first number of samples included in the extra CP 1001 and the second CP configuration may be associated with the second number of samples included in the NCP 1005.

At 1406, the UE may transmit an SRS using the first CP-length configuration. For example, 1406 may be performed by application processor 1706, cellular baseband processor 1724, transceiver(s) 1722, antenna(s) 1780, and/or CP for joint sensing and communication component 198 of FIG. 17. In some aspects, the first CP-length configuration associated with the SRS is different from a second CP-length configuration associated with communication. The SRS, in some aspects, may be transmitted at 1406 using an FMCW. In some aspects, the SRS transmitted at 1406 includes a set of SRS instances associated with a first periodicity and spanning an SRS CPI including multiple slots. The SRS, in some aspects, may be transmitted via a resource pool dedicated, configured, or indicated for at least one SRS transmission, or a BWP dedicated, configured, or indicated for the at least one SRS transmission. For example, referring to FIGS. 9 and 11, the UE 1104 may transmit SRS transmission 1118 using the CP-length configuration associated with an SRS transmission based on the CP configuration indication 1114 via a dedicated/sensing resource pool, or a dedicated/sensing BWP, e.g., the SRS resources 960.

At 1408, the UE may receive a reflected SRS based on transmitting the SRS. For example, 1408 may be performed by application processor 1706, cellular baseband processor 1724, transceiver(s) 1722, antenna(s) 1780, and/or CP for joint sensing and communication component 198 of FIG. 17. The received reflected SRS, in some aspects, may be reflected from an object in the environment of the UE. For example, referring to FIG. 11, the UE 1104 may receive the reflected SRS 1120 and the reflected SRS 1122 based on the SRS transmission 1118 being reflected from device 1107 and object 1109, respectively.

At 1410, the UE may receive, based on the SRS, an indication of at least one value associated with a corresponding at least one object in an environment of the wireless device. For example, 1410 may be performed by application processor 1706, cellular baseband processor 1724, transceiver(s) 1722, antenna(s) 1780, and/or CP for joint sensing and communication component 198 of FIG. 17. In some aspects, the at least one value may include at least one of a velocity, a relative velocity, a distance, and/or a relative position associated with the corresponding at least one object. The indication of the at least one value associated with the corresponding at least one object in an environment of the wireless device, in some aspects, may be received from another network device (e.g., a base station or sensing-capable UE) that receives reflections of the SRS transmitted at 1406 and, based on knowledge of the first CP-length configuration (and, in some aspects, the allocated resources for the SRS transmitted at 1406), calculates the at least one value associated with the corresponding at least one object based on the reflected SRS it receives that it then transmits to be received at the UE at 1410. For example, referring to FIG. 11, the UE 1104 may receive the calculated value(s) 1125 and 1127 regarding the device 1107 and the object 1109 from the device 1107 and the base station 1102, respectively, based on the SRS transmission 1118 (and the reflected SRS 1120 and the reflected SRS 1122).

Finally, at 1412, the UE may calculate at least one value associated with a corresponding at least one object in the environment of the wireless device based on the SRS and the reflected SRS. For example, 1412 may be performed by application processor 1706, cellular baseband processor 1724, and/or CP for joint sensing and communication component 198 of FIG. 17. In some aspects, calculating the at least one value may include calculating at least one of a velocity, a relative velocity, a distance, and/or a relative position associated with the corresponding at least one object. The calculation may be based on a Doppler shift in the frequencies of the reflected SRS. The calculation, in some aspects, may further be based on the indication of at least one value associated with a corresponding at least one object received from another network device. For example, referring to FIG. 11, the UE 1104 may calculate the at least one value at 1128, where calculating the at least one value may be based on the SRS transmission 1118, the reflected SRS 1120, and/or the reflected SRS 1122 and may further be based on the calculated value(s) 1125 and 1127 regarding the device 1107 and the object 1109 received from the device 1107 and the base station 1102, respectively.

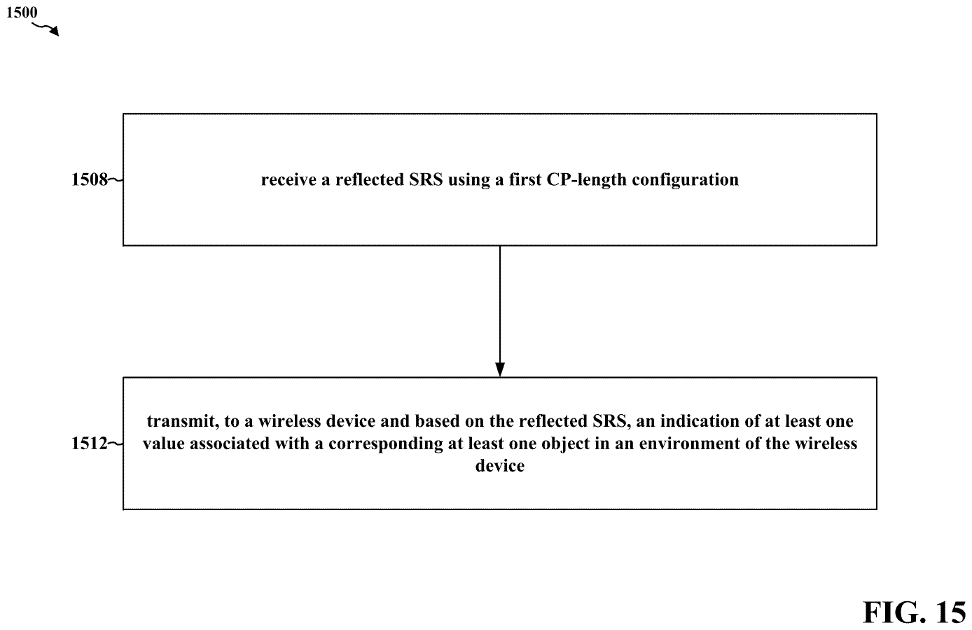

FIG. 15 is a flowchart 1500 of a method of wireless communication associated with a sensing operation. The method may be performed by a network device such as a base station, vehicular UE, or UE (e.g., the base station 102 or 1102; the network device 512; the vehicular UE 511; the device 1107; the UE 513, 1105; the network entity 1702, 1802, 1960). In some aspects, a first wireless device, may transmit an SRS using first CP-length configuration associated with sensing signal transmissions, a sensing operation, or sensing resources. The SRS, in some aspects, may be transmitted using an FMCW. In some aspects, the SRS includes a set of SRS instances associated with a first periodicity and spanning an SRS CPI including multiple slots. The first CP-length configuration may be associated with, or configured for, one or more particular SRS transmissions (e.g., one or more sets of SRS instances each spanning an SRS CPI) for the wireless device or may be associated with a resource pool or BWP for subsequent allocation to, or scheduling for, wireless devices performing sensing operations (e.g., via SRS transmissions). In some aspects, the first CP-length configuration may be one of a UE-specific configuration, a cell-specific configuration, or a group-common configuration. In some aspects, the first CP-length configuration associated with the SRS is different from a second CP-length configuration associated with communication. For example, referring to FIG. 11, the base station 1102 may configure, at 1112, a (first) CP-length configuration for the UE 1104 (and a third CP-length configuration for the UE 1105) associated with a distribution of CP among subframes, half subframes, slots, and/or symbols associated with sensing signal transmissions (e.g., one of the CP configurations described in relation to FIGS. 8-10).

The first CP-length configuration, in some aspects, may be configured to ensure that a set of SRS instances transmitted using, or associated with, the first CP-length configuration are equally-spaced in time during the SRS CPI. In some aspects, the first CP-length configuration includes an equal-length CP associated with each symbol of a CPI for the SRS that spans a plurality of slots. The first CP-length configuration, in some aspects, includes an ECP associated with the equal-length CP, and the second CP-length configuration includes an NCP. For example, referring to FIG. 8 the first CP-length configuration may specify a slot including 12 symbols each associated with an equal-length CP (e.g., an equal length CP including 1024 samples).

The first CP-length configuration, in some aspects, may be associated with a first CP including a first number of samples at a beginning of a CPI for the SRS (before a first symbol of the SRS) that is different from a second number of samples associated with a second CP included in, or associated with, subsequent symbols of the CPI. In some aspects, the first number of samples is based on a duration of the CPI for the SRS. For example, referring to FIG. 9, the first CP may correspond to the extra CP for SRS 901 (or CP_{SRS}) that may include a first number of samples that may be an integer multiple (e.g., n=N/0.5) of an extra CP for communication 921 based on the length N of the set of resources (or a periodicity 1/N of a set of periodic resources) associated with sensing signal transmissions (e.g., resources associated with the first CP-length configuration).

In some aspects, the first CP-length configuration may include a first CP configuration associated with a first number of samples and a second CP configuration associated with a second number of samples that is smaller than the first number of samples. The first CP configuration, in some aspects, may be associated with a first symbol in each half of each slot associated with the SRS (or the SRS CPI) and the second CP configuration may be associated with remaining symbols of each slot associated with the SRS (or the SRS CPI). In some aspects, the first CP configuration, may be associated with a first symbol in each half of each slot associated with the SRS (or the SRS CPI) and the second CP configuration may be associated with remaining symbols of each slot associated with the SRS (or the SRS CPI). In some aspects, first CP configuration, may be associated with a first symbol in each of a set of units including an integer number of half slots associated with the SRS (or the SRS CPI) and the second CP configuration may be associated with remaining symbols of each slot associated with the SRS (or the SRS CPI). For example, referring to FIG. 10, the first CP configuration may be associated with the first number of samples included in the extra CP 1001 and the second CP configuration may be associated with the second number of samples included in the NCP 1005.

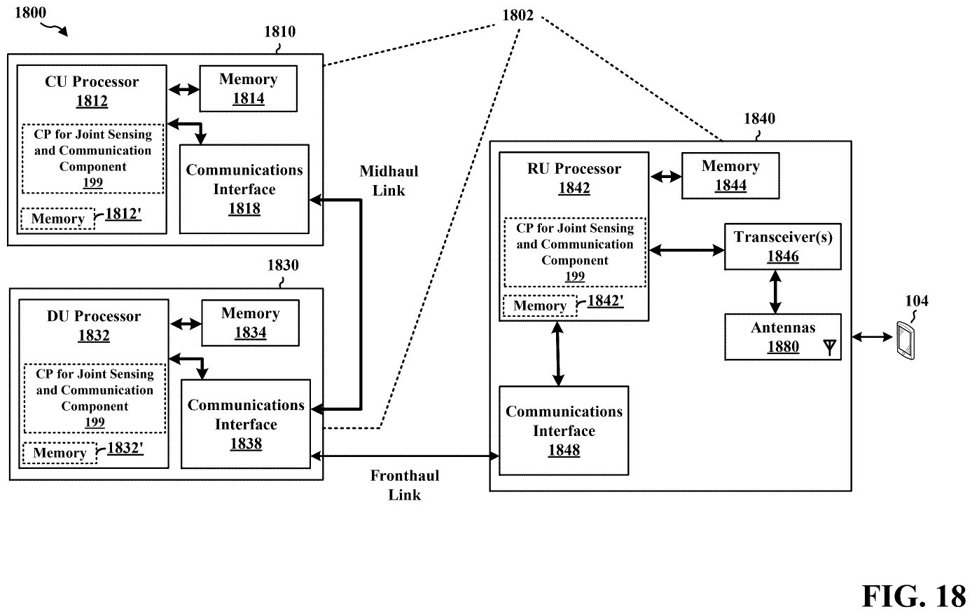

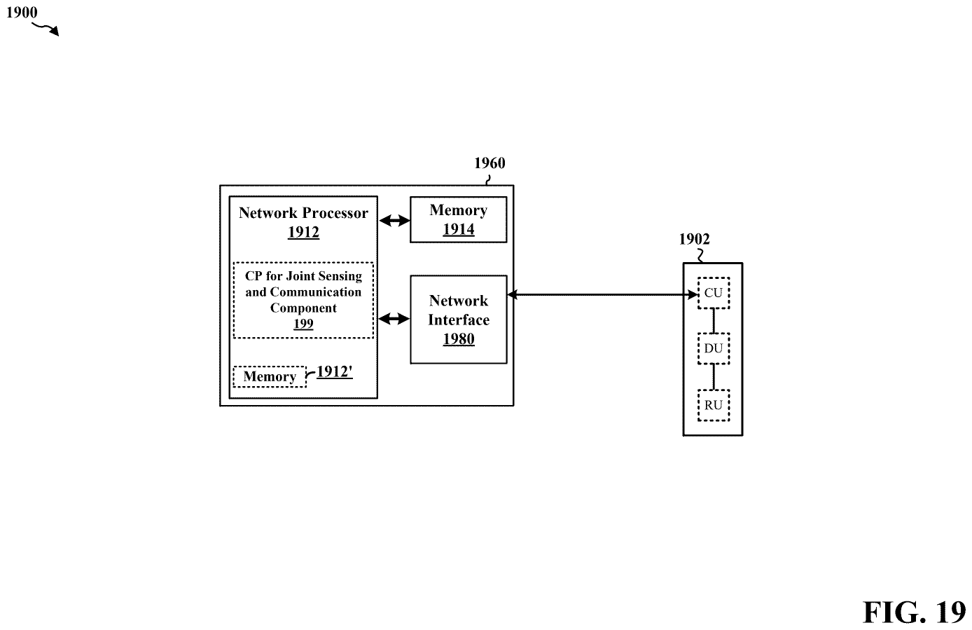

At 1508, the network device may receive a reflected SRS. For example, 1508 may be performed by CU processor 1812, DU processor 1832, RU processor 1842, transceiver(s) 1846, antenna(s) 1880, network processor 1912, network interface 1980, and/or CP for joint sensing and communication component 199 of FIGS. 18 and 19. In some aspects, the reflected SRS may be based on the SRS transmitted by the wireless device. The received reflected SRS, in some aspects, may be reflected from an object in the environment of the network device (and the wireless device). For example, referring to FIG. 11, the base station 1102 (or the device 1107) may receive the reflected SRS 1120 and the reflected SRS 1122 (or the reflected SRS 1122) based on the SRS transmission 1118 being reflected from the device 1107 and the object 1109 (or reflected from the object 1109), respectively.

The network device may calculate at least one value associated with a corresponding at least one object in the environment of the wireless device based on the reflected SRS. In some aspects, calculating the at least one value may include calculating at least one of a velocity, a relative velocity, a distance, and/or a relative position associated with the corresponding at least one object. The calculation may be based on a Doppler shift in the frequencies of the reflected SRS. For example, referring to FIG. 11, the base station 1102 (or the device 1107) may calculate the at least one value at 1126 (or at 1124) where calculating the at least one value may be based on the SRS transmission 1118, the reflected SRS 1120, and/or the reflected SRS 1122.

At 1512, the network device may transmit, to a wireless device and based on the reflected SRS, an indication of the at least one value associated with the corresponding at least one object in the environment of the wireless device. For example, 1512 may be performed by CU processor 1812, DU processor 1832, RU processor 1842, transceiver(s) 1846, antenna(s) 1880, network processor 1912, network interface 1980, and/or CP for joint sensing and communication component 199 of FIGS. 18 and 19. In some aspects, the at least one value may include at least one of a velocity, a relative velocity, a distance, and/or a relative position associated with the corresponding at least one object. The indication of the at least one value associated with the corresponding at least one object in an environment of the wireless device, in some aspects, may be transmitted to a wireless device transmitting the SRS. For example, referring to FIG. 11, the base station 1102 (and the device 1107) may transmit the calculated value(s) 1127 (and the calculated value(s) 1125) regarding the device 1107 and the object 1109, based on the SRS transmission 1118 (and the reflected SRS 1120 and the reflected SRS 1122).

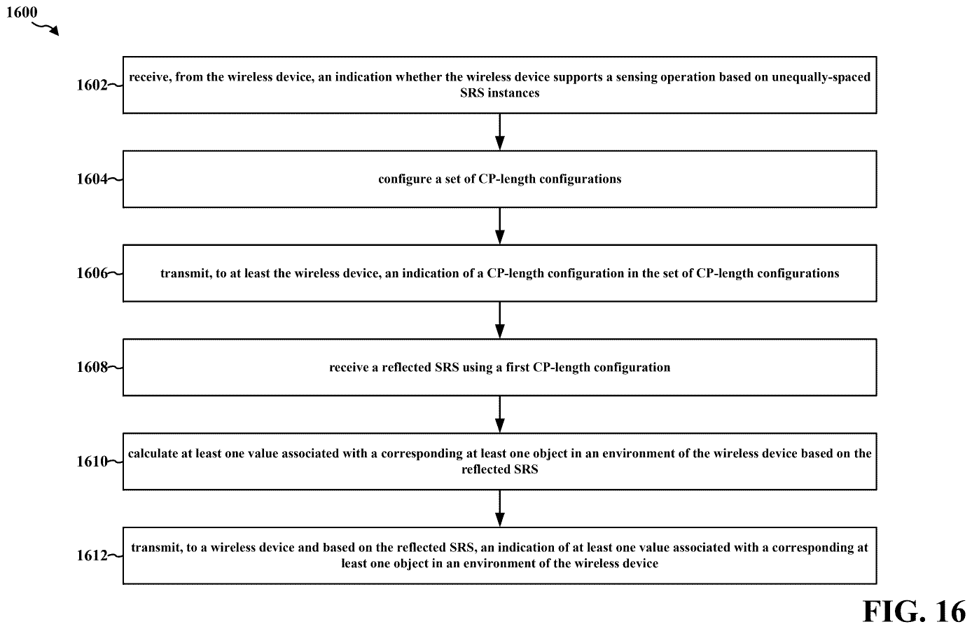

FIG. 16 is a flowchart 1600 of a method of wireless communication associated with a sensing operation. The method may be performed by a network device such as a base station, vehicular UE, or UE (e.g., the base station 102 or 1102; the network device 512; the vehicular UE 511; the device 1107; the UE 513, 1105; the network entity 1702, 1802, 1960). At 1602, the network device may receive, from a wireless device, a capability indication that the wireless device does not support (or is not configured to perform) a sensing operation based on unequally-spaced SRS instances. For example, 1602 may be performed by CU processor 1812, DU processor 1832, RU processor 1842, transceiver(s) 1846, antenna(s) 1880, network processor 1912, network interface 1980, and/or CP for joint sensing and communication component 199 of FIGS. 18 and 19. The UE, in some aspects, may not be configured to perform a more complicated processing associated with unequally-spaced SRS instances (or non-uniform SRS intervals). For example, referring to FIG. 11, the UE 1104 may transmit, and the base station 1102 may receive, the SRS capability indication 1110 that indicates that the UE 1104 (e.g., the wireless device) does not support (or is not configured to perform) a sensing operation based on unequally-spaced SRS instances (e.g., non-uniform SRS intervals).

At 1604, the network device may configure, based on the (capability) indication, a set of CP-length configurations. For example, 1604 may be performed by CU processor 1812, DU processor 1832, RU processor 1842, transceiver(s) 1846, antenna(s) 1880, network processor 1912, network interface 1980, and/or CP for joint sensing and communication component 199 of FIGS. 18 and 19. In some aspects, the set of CP-length configurations includes a first CP-length configuration associated with a first wireless device and may further include a third CP-length configuration associated with a second wireless device. The third CP-length configuration may be mostly independent of the first CP-length configuration but the following discussion of the first CP-length, in some aspects, applies to both the first and third CP-length configurations. The first CP-length configuration may be associated with, or configured for, one or more particular SRS transmissions (e.g., one or more sets of SRS instances each spanning an SRS CPI) for the wireless device or may be associated with a resource pool or BWP for subsequent allocation to, or scheduling for, wireless devices performing sensing operations (e.g., via SRS transmissions). In some aspects, the first CP-length configuration may be one of a UE-specific configuration, a cell-specific configuration, or a group-common configuration. In some aspects, the first CP-length configuration associated with the SRS is different from a second CP-length configuration associated with communication. For example, referring to FIG. 11, the base station 1102 may configure, at 1112, a (first) CP-length configuration for the UE 1104 (and a third CP-length configuration for the UE 1105) associated with a distribution of CP among subframes, half subframes, slots, and/or symbols associated with sensing signal transmissions (e.g., one of the CP configurations described in relation to FIGS. 8-10).

The first CP-length configuration, in some aspects, may be configured to ensure that a set of SRS instances transmitted using, or associated with, the first CP-length configuration are equally-spaced in time during the SRS CPI. In some aspects, the first CP-length configuration includes an equal-length CP associated with each symbol of a CPI for the SRS that spans a plurality of slots. The first CP-length configuration, in some aspects, includes an ECP associated with the equal-length CP, and the second CP-length configuration includes an NCP. For example, referring to FIG. 8 the first CP-length configuration may specify a slot including 12 symbols each associated with an equal-length CP (e.g., an equal length CP including 1024 samples).

The first CP-length configuration, in some aspects, may be associated with a first CP including a first number of samples at a beginning of a CPI for the SRS (before a first symbol of the SRS) that is different from a second number of samples associated with a second CP included in, or associated with, subsequent symbols of the CPI. In some aspects, the first number of samples is based on a duration of the CPI for the SRS. For example, referring to FIG. 9, the first CP may correspond to the extra CP for SRS 901 (or CP_{SRS}) that may include a first number of samples that may be an integer multiple (e.g., n=N/0.5) of an extra CP for communication 921 based on the length N of the set of resources (or a periodicity 1/N of a set of periodic resources) associated with sensing signal transmissions (e.g., resources associated with the first CP-length configuration).

In some aspects, the first CP-length configuration may include a first CP configuration associated with a first number of samples and a second CP configuration associated with a second number of samples that is smaller than the first number of samples. The first CP configuration, in some aspects, may be associated with a first symbol in each half of each slot associated with the SRS (or the SRS CPI) and the second CP configuration may be associated with remaining symbols of each slot associated with the SRS (or the SRS CPI). In some aspects, the first CP configuration, may be associated with a first symbol in each half of each slot associated with the SRS (or the SRS CPI) and the second CP configuration may be associated with remaining symbols of each slot associated with the SRS (or the SRS CPI). In some aspects, first CP configuration, may be associated with a first symbol in each of a set of units including an integer number of half slots associated with the SRS (or the SRS CPI) and the second CP configuration may be associated with remaining symbols of each slot associated with the SRS (or the SRS CPI). For example, referring to FIG. 10, the first CP configuration may be associated with the first number of samples included in the extra CP 1001 and the second CP configuration may be associated with the second number of samples included in the NCP 1005.

At 1606, the network device may transmit, to at least the first wireless device, an indication of a CP-length configuration in the set of CP-length configurations. For example, 1606 may be performed by CU processor 1812, DU processor 1832, RU processor 1842, transceiver(s) 1846, antenna(s) 1880, network processor 1912, network interface 1980, and/or CP for joint sensing and communication component 199 of FIGS. 18 and 19. In some aspects, the network device may transmit the first CP-length configuration to the first wireless device and/or may transmit the third CP-length configuration to the second wireless device. For example, referring to FIG. 11, the base station 1102 may transmit, and the UE 1104 and/or the UE 1105 may receive, the CP configuration indication 1114 and/or the CP configuration indication 1116, respectively, indicating one or more CP-length configurations associated with an SRS transmission, a dedicated/sensing resource pool, or a dedicated/sensing BWP.

The first wireless device, in some aspects may transmit an SRS using the first CP-length configuration. The SRS, in some aspects, may be transmitted using an FMCW. In some aspects, the SRS includes a set of SRS instances associated with a first periodicity and spanning an SRS CPI including multiple slots. At 1608, the network device may receive a reflected SRS. For example, 1608 may be performed by CU processor 1812, DU processor 1832, RU processor 1842, transceiver(s) 1846, antenna(s) 1880, network processor 1912, network interface 1980, and/or CP for joint sensing and communication component 199 of FIGS. 18 and 19. In some aspects, the reflected SRS may be based on the SRS transmitted by the wireless device. The received reflected SRS, in some aspects, may be reflected from an object in the environment of the network device (and the wireless device). For example, referring to FIG. 11, the base station 1102 (or the device 1107) may receive the reflected SRS 1120 and the reflected SRS 1122 (or the reflected SRS 1122) based on the SRS transmission 1118 being reflected from the device 1107 and the object 1109 (or reflected from the object 1109), respectively.

At 1610, the network device may calculate at least one value associated with a corresponding at least one object in the environment of the wireless device based on the reflected SRS. For example, 1610 may be performed by CU processor 1812, DU processor 1832, RU processor 1842, network processor 1912, and/or CP for joint sensing and communication component 199 of FIGS. 18 and 19. In some aspects, calculating the at least one value may include calculating at least one of a velocity, a relative velocity, a distance, and/or a relative position associated with the corresponding at least one object. The calculation may be based on a Doppler shift in the frequencies of the reflected SRS. For example, referring to FIG. 11, the base station 1102 (or the device 1107) may calculate the at least one value at 1126 (or at 1124) where calculating the at least one value may be based on the SRS transmission 1118, the reflected SRS 1120, and/or the reflected SRS 1122.

At 1612, the network device may transmit, to the wireless device and based on the reflected SRS, an indication of the at least one value associated with the corresponding at least one object in the environment of the wireless device. For example, 1612 may be performed by CU processor 1812, DU processor 1832, RU processor 1842, transceiver(s) 1846, antenna(s) 1880, network processor 1912, network interface 1980, and/or CP for joint sensing and communication component 199 of FIGS. 18 and 19. In some aspects, the at least one value may include at least one of a velocity, a relative velocity, a distance, and/or a relative position associated with the corresponding at least one object. The indication of the at least one value associated with the corresponding at least one object in an environment of the wireless device, in some aspects, may be transmitted to a wireless device transmitting the SRS. For example, referring to FIG. 11, the base station 1102 (and the device 1107) may transmit the calculated value(s) 1127 (and the calculated value(s) 1125) regarding the device 1107 and the object 1109, based on the SRS transmission 1118 (and the reflected SRS 1120 and the reflected SRS 1122).

FIG. 17 is a diagram 1700 illustrating an example of a hardware implementation for an apparatus 1704. The apparatus 1704 may be a UE, a component of a UE, or may implement UE functionality. In some aspects, the apparatus 1704 may include a cellular baseband processor 1724 (also referred to as a modem) coupled to one or more transceivers 1722 (e.g., cellular RF transceiver). The cellular baseband processor 1724 may include on-chip memory 1724′. In some aspects, the apparatus 1704 may further include one or more subscriber identity modules (SIM) cards 1720 and an application processor 1706 coupled to a secure digital (SD) card 1708 and a screen 1710. The application processor 1706 may include on-chip memory 1706′. In some aspects, the apparatus 1704 may further include a Bluetooth™ module 1712, a WLAN module 1714, an SPS module 1716 (e.g., GNSS module), one or more sensor modules 1718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1726, a power supply 1730, and/or a camera 1732. The Bluetooth™ module 1712, the WLAN module 1714, and the SPS module 1716 may include an on-chip transceiver (TRX) (or in some cases, just a receiver (RX)). The Bluetooth™ module 1712, the WLAN module 1714, and the SPS module 1716 may include their own dedicated antennas and/or utilize one or more antennas 1780 for communication. The cellular baseband processor 1724 communicates through the transceiver(s) 1722 via the one or more antennas 1780 with the UE 104 and/or with an RU associated with a network entity 1702. The cellular baseband processor 1724 and the application processor 1706 may each include a computer-readable medium/memory 1724′, 1706′, respectively. The additional memory modules 1726 may also be considered a computer-readable medium/memory. Each computer-readable medium/memory 1724′, 1706′, 1726 may be non-transitory. The cellular baseband processor 1724 and the application processor 1706 are each responsible for general processing, including the execution of software stored on the computer-readable medium/memory. The software, when executed by the cellular baseband processor 1724/application processor 1706, causes the cellular baseband processor 1724/application processor 1706 to perform the various functions described supra. The computer-readable medium/memory may also be used for storing data that is manipulated by the cellular baseband processor 1724/application processor 1706 when executing software. The cellular baseband processor 1724/application processor 1706 may be a component of the UE 350 and may include the memory 360 and/or at least one of the TX processor 368, the RX processor 356, and the controller/processor 359. In one configuration, the apparatus 1704 may be a processor chip (modem and/or application) and include just the cellular baseband processor 1724 and/or the application processor 1706, and in another configuration, the apparatus 1704 may be the entire UE (e.g., see UE 350 of FIG. 3) and include the additional modules of the apparatus 1704.

As discussed supra, the CP for joint sensing and communication component 198 may be configured to transmit an SRS using a first CP-length configuration, where the first CP-length configuration is different from a second CP-length configuration associated with communication. The CP for joint sensing and communication component 198 may further be configured to receive a reflected SRS based on transmitting the SRS. The CP for joint sensing and communication component 198 may further be configured to receive, based on the SRS, an indication of at least one value associated with a corresponding at least one object in an environment of the wireless device. The CP for joint sensing and communication component 198 may be within the cellular baseband processor 1724, the application processor 1706, or both the cellular baseband processor 1724 and the application processor 1706. The CP for joint sensing and communication component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1704 may include a variety of components configured for various functions. In one configuration, the apparatus 1704, and in particular the cellular baseband processor 1724 and/or the application processor 1706, may include means for transmitting an SRS using a first CP-length configuration, where the first CP-length configuration is different from a second CP-length configuration associated with communication. The apparatus 1704, and in particular the cellular baseband processor 1724 and/or the application processor 1706, in some aspects, may include means for receiving a reflected SRS based on transmitting the SRS. The apparatus 1704, and in particular the cellular baseband processor 1724 and/or the application processor 1706, in some aspects, may include means for receiving, based on the SRS, an indication of at least one value associated with a corresponding at least one object in an environment of the wireless device. The apparatus 1704, and in particular the cellular baseband processor 1724 and/or the application processor 1706, in some aspects, may include means for calculating at least one value associated with a corresponding at least one object in an environment of the wireless device based on the SRS and the reflected SRS. The apparatus 1704, and in particular the cellular baseband processor 1724 and/or the application processor 1706, in some aspects, may include means for receiving, from the network device, a first indication of the first CP-length configuration, wherein the wireless device is associated with a vehicle. The apparatus 1704, and in particular the cellular baseband processor 1724 and/or the application processor 1706, in some aspects, may include means for transmitting, for the network device, a second indication that the wireless device does not support a sensing operation based on unequally-spaced SRS instances, wherein receiving the first indication of the first CP-length configuration is based on the second indication. The means may be the CP for joint sensing and communication component 198 of the apparatus 1704 configured to perform the functions recited by the means. As described supra, the apparatus 1704 may include the TX processor 368, the RX processor 356, and the controller/processor 359. As such, in one configuration, the means may be the TX processor 368, the RX processor 356, and/or the controller/processor 359 configured to perform the functions recited by the means or as described in relation to FIGS. 12-14.

FIG. 18 is a diagram 1800 illustrating an example of a hardware implementation for a network entity 1802. The network entity 1802 may be a BS, a component of a BS, or may implement BS functionality. The network entity 1802 may include at least one of a CU 1810, a DU 1830, or an RU 1840. For example, depending on the layer functionality handled by the component 199, the network entity 1802 may include the CU 1810; both the CU 1810 and the DU 1830; each of the CU 1810, the DU 1830, and the RU 1840; the DU 1830; both the DU 1830 and the RU 1840; or the RU 1840. The CU 1810 may include a CU processor 1812. The CU processor 1812 may include on-chip memory 1812′. In some aspects, the CU 1810 may further include additional memory modules 1814 and a communications interface 1818. The CU 1810 communicates with the DU 1830 through a midhaul link, such as an F1 interface. The DU 1830 may include a DU processor 1832. The DU processor 1832 may include on-chip memory 1832′. In some aspects, the DU 1830 may further include additional memory modules 1834 and a communications interface 1838. The DU 1830 communicates with the RU 1840 through a fronthaul link. The RU 1840 may include an RU processor 1842. The RU processor 1842 may include on-chip memory 1842′. In some aspects, the RU 1840 may further include additional memory modules 1844, one or more transceivers 1846, one or more antennas 1880, and a communications interface 1848. The RU 1840 communicates with the UE 104. The on-chip memory 1812′, 1832′, 1842′ and the additional memory modules 1814, 1834, 1844 may each be considered a computer-readable medium/memory. Each computer-readable medium/memory may be non-transitory. Each of the processors 1812, 1832, 1842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CP for joint sensing and communication component 199 may be configured to receive a reflected SRS using a first CP-length configuration, where the first CP-length configuration is different from a second CP-length configuration associated with communication. The CP for joint sensing and communication component 199 may further be configured to transmit, to a wireless device and based on the reflected SRS, an indication of at least one value associated with a corresponding at least one object in an environment of the wireless device. The CP for joint sensing and communication component 199 may be within one or more processors of one or more of the CU 1810, DU 1830, and the RU 1840. The CP for joint sensing and communication component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1802 may include a variety of components configured for various functions. In one configuration, the network entity 1802 may include means for receiving a reflected SRS using a first CP-length configuration, wherein the first CP-length configuration is different from a second CP-length configuration associated with communication. The network entity 1802, in some aspects, may include means for transmitting, to a wireless device and based on the reflected SRS, an indication of at least one value associated with a corresponding at least one object in an environment of the wireless device. The network entity 1802, in some aspects, may include means for calculating the at least one value based on the reflected SRS. The network entity 1802, in some aspects, may include means for receiving, from the wireless device, a second indication that the wireless device does not support a sensing operation based on unequally-spaced SRS instances. The network entity 1802, in some aspects, may include means for configuring, based on the second indication, the first CP-length configuration. The network entity 1802, in some aspects, may include means for transmitting, to the wireless device, a third indication of the first CP-length configuration. The network entity 1802, in some aspects, may include means for configuring a third CP-length configuration for a second wireless device. The network entity 1802, in some aspects, may include means for transmitting, to the second wireless device, a fourth indication of the third CP-length configuration. The means may be the CP for joint sensing and communication component 199 of the network entity 1802 configured to perform the functions recited by the means. As described supra, the network entity 1802 may include the TX processor 316, the RX processor 370, and the controller/processor 375. As such, in one configuration, the means may be the TX processor 316, the RX processor 370, and/or the controller/processor 375 configured to perform the functions recited by the means or as described in relation to FIGS. 15 and 16.

FIG. 19 is a diagram 1900 illustrating an example of a hardware implementation for a network entity 1960. In one example, the network entity 1960 may be within the core network 120. The network entity 1960 may include a network processor 1912. The network processor 1912 may include on-chip memory 1912′. In some aspects, the network entity 1960 may further include additional memory modules 1914. The network entity 1960 communicates via the network interface 1980 directly (e.g., backhaul link) or indirectly (e.g., through a RIC) with the CU 1902. The on-chip memory 1912′ and the additional memory modules 1914 may each be considered a computer-readable medium/memory. Each computer-readable medium/memory may be non-transitory. The processor 1912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the CP for joint sensing and communication component 199 may be configured to receive a reflected SRS using a first CP-length configuration, where the first CP-length configuration is different from a second CP-length configuration associated with communication. The CP for joint sensing and communication component 199 may further be configured to transmit, to a wireless device and based on the reflected SRS, an indication of at least one value associated with a corresponding at least one object in an environment of the wireless device. The CP for joint sensing and communication component 199 may be within the processor 1912. The CP for joint sensing and communication component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1960 may include a variety of components configured for various functions. In one configuration, the network entity 1960 may include means for receiving a reflected SRS using a first CP-length configuration, wherein the first CP-length configuration is different from a second CP-length configuration associated with communication. The network entity 1960, in some aspects, may include means for transmitting, to a wireless device and based on the reflected SRS, an indication of at least one value associated with a corresponding at least one object in an environment of the wireless device. The network entity 1960, in some aspects, may include means for calculating the at least one value based on the reflected SRS. The network entity 1960, in some aspects, may include means for receiving, from the wireless device, a second indication that the wireless device does not support a sensing operation based on unequally-spaced SRS instances. The network entity 1960, in some aspects, may include means for configuring, based on the second indication, the first CP-length configuration. The network entity 1960, in some aspects, may include means for transmitting, to the wireless device, a third indication of the first CP-length configuration. The network entity 1960, in some aspects, may include means for configuring a third CP-length configuration for a second wireless device. The network entity 1960, in some aspects, may include means for transmitting, to the second wireless device, a fourth indication of the third CP-length configuration. The means may be the CP for joint sensing and communication component 199 of the network entity 1960 configured to perform the functions recited by the means or as described in relation to FIGS. 15 and 16.

Various aspects of the disclosure relate generally to jointly designed sensing and communication systems. In some aspects, the joint sensing and communication system may be applied for automotive applications, among other example applications, that have the potential to reduce hardware costs, e.g., as components may be jointly used for sensing and communication rather than having separate communication components and sensing components. In a joint sensing and communication system, a devices communication system (e.g., a UE, which may be located at, or associated with, a vehicle) may transmit signals for sensing, e.g., to detect objects around the device based on reflections of the transmitted signals. As one example, a vehicle may use the joint communication system to perform sensing around the vehicle. For example, in a monostatic mode of operation the reflections may be received by the UE's communication system (e.g., which may be located at, or associated with, a vehicle, while in a bistatic mode of operation the reflections may be received by another device (e.g., a UE or base station) and information based on the reflections may be provided to the vehicle. The communication system, in some aspects, may transmit sensing signals using a mmWave band that is additionally designated for wireless communication but may be underutilized. In some aspects, a UE may transmit a sensing signal (e.g., a plurality of transmissions for a sensing operation) on uplink resources of a wireless communication network. For example, the sensing signal may use the same waveform as being used in the communication system (e.g., CP-OFDM). In some aspects, an SRS may be specified based on minimum accuracy or resolution. The resources used for an SRS transmission, in some aspects, may be configured or allocated by a network entity, e.g., a base station or network node.

Velocity estimation, in some aspects, may be important for automotive applications, among other example applications, and particular accuracy and/or resolution may be associated with a duration of an SRS. For example, an SRS transmission lasting 5 ms or longer, which may be referred to as a CPI in the context of RADAR, may be a minimum time interval to achieve 1 m/s velocity resolution. During the SRS transmission, e.g., the CPI, a plurality of SRS instances may be transmitted with an interval based on a range of velocities to be identified and/or estimated using the SRS instances. The SRS may span a number, N, of slots (or ms), and the SRS instances may be transmitted via a subset of symbols within the within the N slots (or ms).

If an interval (e.g., an SRS interval or SRS transmission interval) between SRS instances is constant/equal for different SRS instances, a first processing of the SRS instances may be used for velocity determination. For unequal intervals between the SRS instances, a second, more sophisticated and/or more complicated processing of the SRS instances may be used for velocity determination. The decision to use one of equal, or unequal, intervals may be based on balancing the complexity of processing the SRS instances and a complexity of maintaining acceptable overhead to support system capacity for sensing while minimizing impact to communication performance.

For example, in some aspects, a wireless device may transmit an SRS using a first CP-length configuration, where the first CP-length configuration is different from a second CP-length configuration associated with communication. The wireless device, in a monostatic mode of operation, may receive a reflected SRS based on transmitting the SRS and may calculate at least one value associated with a corresponding at least one object in an environment of the wireless device based on the SRS and the reflected SRS. In a bistatic mode of operation, a base station, or other wireless device, may receive the reflected SRS using the first CP-length configuration and calculating at least one value associated with a corresponding at least one object in an environment of the wireless device based on the SRS and the reflected SRS. The base station, or other wireless device, may transmit, and the wireless device transmitting the SRS may receive, an indication of the at least one value. The SRS may include a set of SRS instances with a first periodicity (e.g., an interval in time between SRS instances or a number of symbols between SRS instances) over multiple slots and/or ms, where the first CP-length configuration is configured to maintain equal intervals in time based on a number of symbols between SRS instances.

Particular aspects of the subject matter described in this disclosure can be implemented to realize one or more of the following potential advantages. The CP-length configuration may be used to simplify SRS processing for sensing applications performed by a joint sensing and communication wireless device.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, including transmitting a SRS using a first CP-length configuration, where the first CP-length configuration is different from a second CP-length configuration associated with communication and receiving a reflected SRS based on transmitting the SRS.

Aspect 2 is the method of aspect 1, further including calculating at least one value associated with a corresponding at least one object in an environment of the wireless device based on the SRS and the reflected SRS.

Aspect 3 is the method of aspect 2, where the at least one value comprises a velocity associated with the corresponding at least one object based on the at least one value calculated using the reflected SRS.

Aspect 4 is the method of any of aspects 1 to 2, where the SRS comprises a set of SRS instances associated with a first periodicity and spanning an SRS CPI comprising multiple slots.

Aspect 5 is the method of any of aspects 1 to 4, wherein the SRS is transmitted in one of a resource pool dedicated, configured, or indicated for at least one SRS transmission, or a BWP dedicated, configured, or indicated for the at least one SRS transmission.

Aspect 6 is the method of any of aspects 1 to 5, where the first CP-length configuration comprises an equal-length CP associated with each symbol of a CPI for the SRS that spans a plurality of slots.

Aspect 7 is the method of aspect 6, where the first CP-length configuration comprises an ECP, and the second CP-length configuration comprises an NCP.

Aspect 8 is the method of any of aspects 1 to 5, where the first CP-length configuration is associated with a first CP comprising a first number of samples at a beginning of a CPI for the SRS that is different from a second number of samples associated with a second CP included in subsequent symbols of the CPI.

Aspect 9 is the method of aspect 8, where the first number of samples is based on a duration of the CPI for the SRS.

Aspect 10 is the method of any of aspects 8 and 9, where the first CP-length configuration includes an NCP length.

Aspect 11 is the method of any of aspects 1 to 10, where transmitting the SRS comprises transmitting the SRS using a frequency modulated continuous wave.

Aspect 12 is the method of any of aspects 1 to 5 and 11, where the first CP-length configuration comprises a first CP configuration associated with a first number of samples and a second CP configuration associated with a second number of samples that is a smaller than the first number of samples, where the first CP configuration is associated with a first symbol in each half of each slot associated with the SRS and the second CP configuration is associated with remaining symbols of each slot associated with the SRS.

Aspect 13 is the method of any of aspects 1 to 12, where the first CP-length configuration and the second CP-length configuration are configured by a network device that is at least one of a base station, an additional wireless device, or a network entity associated with the wireless device, the method further including receiving, from the network device, a first indication of the first CP-length configuration, wherein the wireless device is associated with a vehicle.

Aspect 14 is the method of aspect 13, further including transmitting, for the network device, a second indication indicating whether the wireless device supports a sensing operation based on unequally-spaced SRS instances, where receiving the first indication of the first CP-length configuration is based on the second indication.

Aspect 15 is a method of wireless communication at a network device, including receiving a reflected SRS using a first CP-length configuration, wherein the first CP-length configuration is different from a second CP-length configuration associated with communication and transmitting, to a wireless device and based on the reflected SRS, an indication of at least one value associated with a corresponding at least one object in an environment of the wireless device.

Aspect 16 is the method of aspect 15, where the at least one value comprises a relative speed of the corresponding at least one object, the method further including calculating the at least one value based on the reflected SRS.

Aspect 17 is the method of any of aspects 15 and 16, where the SRS originated from the wireless device.

Aspect 18 is the method of any of aspects 15 to 17, further including receiving, from the wireless device, a second indication indicating whether the wireless device supports a sensing operation based on unequally-spaced SRS instances, configuring, based on the second indication, the first CP-length configuration, and transmitting, to the wireless device, a third indication of the first CP-length configuration.

Aspect 19 is the method of any of aspects 15 to 18, where the first CP-length configuration is associated with one of a resource pool or a BWP for SRS transmission and the second CP-length configuration is associated with a set of resources for the communication.

Aspect 20 is the method of aspect 19, where the first CP-length configuration is associated with a plurality of wireless devices.

Aspect 21 is the method of any of aspects 18 and 19, where the wireless device is a first wireless device, where configuring the first CP-length configuration comprises configuring the first CP-length configuration for the first wireless device, the method further including configuring a third CP-length configuration for a second wireless device, and transmitting, to the second wireless device, a fourth indication of the third CP-length configuration.

Aspect 22 is the method of any of aspects 15 to 21, where the network device is one of a base station, an additional wireless device, or a network entity associated with the wireless device, and where the wireless device is one of a UE or a vehicle.

Aspect 23 is a method of wireless communication for a wireless device, including transmitting a SRS using a first CP-length configuration, where the first CP-length configuration is different from a second CP-length configuration associated with communication, and receiving, based on the SRS, an indication of at least one value associated with a corresponding at least one object in an environment of the wireless device.

Aspect 24 is the method of aspect 23, further including receiving a reflected SRS based on transmitting the SRS.

Aspect 25 is an apparatus for wireless communication at a device including a memory and at least one processor coupled to the memory and, based at least in part on information stored in the memory, the at least one processor is configured to implement any of aspects 1 to 24.

Aspect 26 is the method of aspect 25, further including a transceiver or an antenna coupled to the at least one processor.

Aspect 27 is an apparatus for wireless communication at a device including means for implementing any of aspects 1 to 24.

Aspect 28 is a computer-readable medium (e.g., a non-transitory computer-readable medium) storing computer executable code, where the code when executed by a processor causes the processor to implement any of aspects 1 to 24.

1. An apparatus for wireless communication at a wireless device, comprising:
a memory; and
at least one processor coupled to the memory and, based at least in part on information stored in the memory, the at least one processor is configured to:
transmit a sensing reference signal (SRS) using a first cyclic prefix (CP)-length configuration, wherein the first CP-length configuration is different from a second CP-length configuration associated with communication; and receive a reflected SRS based on transmitting the SRS.

2. The apparatus of claim 1, wherein the at least one processor is further configured to:
calculate at least one value associated with a corresponding at least one object in an environment of the wireless device based on the SRS and the reflected SRS.

3. The apparatus of claim 2, wherein the at least one value comprises a relative speed associated with the corresponding at least one object based on the SRS and the reflected SRS.

4. The apparatus of claim 1, wherein the SRS comprises a set of SRS instances associated with a first periodicity and spanning an SRS coherent processing interval (CPI) comprising multiple slots.

5. The apparatus of claim 1, wherein the SRS is transmitted in one of:
a resource pool dedicated, configured, or indicated for at least one SRS transmission, or
a bandwidth part (BWP) dedicated, configured, or indicated for the at least one SRS transmission.

6. The apparatus of claim 1, wherein the first CP-length configuration comprises an equal-length CP associated with each symbol of a coherent processing interval (CPI) for the SRS that spans a plurality of slots.

7. The apparatus of claim 6, wherein the first CP-length configuration comprises an extended cyclic prefix (ECP), and the second CP-length configuration comprises a normal cyclic prefix (NCP).

8. The apparatus of claim 1, wherein the first CP-length configuration is associated with a first CP comprising a first number of samples at a beginning of a coherent processing interval (CPI) for the SRS that is different from a second number of samples associated with a second CP included in subsequent symbols of the CPI.

9-10. (canceled)

11. The apparatus of claim 1, wherein to transmit the SRS the at least one processor is configured to transmit the SRS using a frequency modulated continuous wave.

12. The apparatus of claim 1, wherein the first CP-length configuration comprises a first CP configuration associated with a first number of samples and a second CP configuration associated with a second number of samples that is a smaller than the first number of samples, wherein the first CP configuration is associated with a first symbol in each half of each slot associated with the SRS and the second CP configuration is associated with remaining symbols of each slot associated with the SRS.

13. The apparatus of claim 1, wherein the first CP-length configuration and the second CP-length configuration are configured by a network device that is at least one of a base station, an additional wireless device, or a network entity associated with the wireless device, wherein the at least one processor is further configured to:
receive, from the network device, a first indication of the first CP-length configuration, wherein the wireless device is associated with a vehicle.

14. The apparatus of claim 13, wherein the at least one processor is further configured to: transmit, for the network device, a second indication indicating whether the wireless device supports a sensing operation based on unequally-spaced SRS instances, wherein the at least one processor is configured to receive the first indication of the first CP-length configuration based on the second indication.

15. An apparatus for wireless communication at a network device, comprising:
a memory; and
at least one processor coupled to the memory and, based at least in part on information stored in the memory, the at least one processor is configured to:
receive a reflected sensing reference signal (SRS) using a first cyclic prefix (CP)-length configuration, wherein the first CP-length configuration is different from a second CP-length configuration associated with communication; and transmit, to a wireless device and based on the reflected SRS, an indication of at least one value associated with a corresponding at least one object in an environment of the wireless device.

16. The apparatus of claim 15, wherein the at least one value comprises a relative speed of the corresponding at least one object, and wherein the at least one processor is further configured to:
calculate the at least one value based on the reflected SRS.

17. The apparatus of claim 15, wherein the SRS originated from the wireless device.

18. The apparatus of claim 16, wherein the at least one processor is further configured to:
receive, from the wireless device, a second indication indicating whether the wireless device supports a sensing operation based on unequally-spaced SRS instances;
configure, based on the second indication, the first CP-length configuration; and transmit, to the wireless device, a third indication of the first CP-length configuration.

19. The apparatus of claim 18, wherein the first CP-length configuration is associated with one of a resource pool or a bandwidth part (BWP) for SRS transmission and the second CP-length configuration is associated with a set of resources for the communication.

20. (canceled)

21. The apparatus of claim 18, wherein the wireless device is a first wireless device, wherein to configure the first CP-length configuration the at least one processor is further configured to configure the first CP-length configuration for the first wireless device, and wherein the at least one processor is further configured to:
configure a third CP-length configuration for a second wireless device; and transmit, to the second wireless device, a fourth indication of the third CP-length configuration.

22. The apparatus of claim 15, wherein the network device is one of a base station, an additional wireless device, or a network entity associated with the wireless device, and wherein the wireless device is one of a user equipment (UE) or a vehicle.

23-26. (canceled)

27. A method of wireless communication for a wireless device, comprising:
transmitting a sensing reference signal (SRS) using a first cyclic prefix (CP)-length configuration, wherein the first CP-length configuration is different from a second CP-length configuration associated with communication; and
receiving a reflected SRS based on transmitting the SRS.

28-30. (canceled)
